(19) United States
(12) Patent Application Publication
(10) Pub. No.: US 2022/0301079 A1
(43) Pub. Date: Sep. 22, 2022

(54) Systems and Methods for Generating and Using Place-Based Social Networks

(71) Applicant: Minha Kim, Goyang-si (KR)

(72) Inventor: Minha Kim, Goyang-si (KR)

(21) Appl. No.: 17/678,388

(22) Filed: Feb. 23, 2022

Related U.S. Application Data
(60) Provisional application No. 63/270,384, filed on Oct. 21, 2021.

(30) Foreign Application Priority Data
Mar. 17, 2021 (KR) 10-2021-0034825

(51) Int. Cl. G06Q 50/00; H04L 51/52; H04L 67/52; H04L 67/306

(52) U.S. Cl. CPC G06Q 50/01; H04L 51/32; H04L 67/18; H04L 67/306

(57) ABSTRACT

Systems, devices, and methods for forming and using a social network based on a space, place, event, or activity. Such a social network enables a set of people with a common interest in an event, place, activity, location, space, setting, experience, etc. to connect directly and enables the space, activity, event, or place to connect with interested people more efficiently and effectively for purposes of promotion, advertising, and offering value-adds to a person's experience with the space, place, event, or activity.

### CROSS REFERENCE TO RELATED APPLICATION

This application claims the benefit of U.S. Provisional Application No. 63/270,384, entitled “Systems And Methods For Generating And Using Place-Based Social Networks,” filed Oct. 21, 2021, and claims priority from Korean Intellectual Property Office Patent Application no. 10-2021-0034825, filed Mar. 17, 2021, the entire disclosures of which are incorporated, in their entirety by this reference.

### BACKGROUND

Social networking applications are used by millions of people around the world to communicate with each other by posting messages or content (such as video and images) or by responding to such posts by others. Each person using the application has an account and invites or is invited by other people to “connect”, thereby permitting posted messages and content to be shared between a person and those they connect with. Each connection is a one-to-one relationship between two individuals, and posted content is typically available to one or more people based on who the person posting selects as being able to view a post (such as those they are connected to).

While convenient and providing a way to facilitate and enhance communication between people who are connected, conventional social networking applications have significant limitations. For example, one consequence of the way in which conventional social networks are implemented is that a person may only be exposed to content posted by others with whom they are connected. This limits the ability of a person to discover new information and experiences if the people with whom they are connected do not share an interest in an event, activity, or content of particular interest to that person.

Further, because conventional social networks are based on individuals and their interests, promoters and advertisers may only be able to indirectly identify people who might be interested in offers or opportunities the promoters and advertisers can provide. These opportunities may include coupons, value-adds to services, unique experiences (such as guided tours or a one-of-a-kind educational or other type of activity), etc. A result is that some promoters and advertisers may not be able to achieve a conversion rate that justifies investing in attempting to interact with members of a conventional social network, or the achieved conversion rate may be low.

Embodiments of the disclosure overcome these and other disadvantages of conventional approaches to using social networks to exchange content or to advertise or promote an event or activity, both collectively and individually.

### SUMMARY

The terms “invention,” “the invention,” “this invention,” “the present invention,” “the present disclosure,” or “the disclosure” as used herein are intended to refer broadly to all the subject matter described in this document, the drawings or figures, and to the claims. Statements containing these terms should be understood not to limit the subject matter described herein or to limit the meaning or scope of the claims. Embodiments covered by this disclosure are defined by the claims and not by this summary. This summary is a high-level overview of various aspects of the disclosure and introduces some of the concepts that are further described in the Detailed Description section below. This summary is not intended to identify key, essential, or required features of the claimed subject matter, nor is it intended to be used in isolation to determine the scope of the claimed subject matter. The subject matter should be understood by reference to appropriate portions of the entire specification, to any or all figures or drawings, and to each claim.

This disclosure is directed to systems, devices, and methods for forming and using a social network based on a space, place, event, or activity as opposed to a set of individuals. This form of social network enables a set of people with a common interest in an event, place, activity, location, space, setting, experience, etc. to “connect” directly and enables the space, activity, event, or place to connect with interested people more efficiently and effectively for purposes of promotion, advertising, and offering value-adds to a person's experience with the space, place, event, or activity, etc.

In one embodiment, the disclosure is directed to a method for forming and using a social network based on a space, place, event, activity, etc. In one example implementation of this embodiment, one or more users of the platform interested in communicating about or promoting a space, place, event, or activity may initiate a process of establishing a space-based social network using the following data processing flow and associated logic:
As indicated, there are two broad categories of users of the services and functionality provided by the disclosed system/platform;
   a first category are visitors to a space, place, location, event, or participants in an activity (or those desiring to visit or participate);
   a second category are administrators or organizers of an event or activity, owners of a place or space, or advertisers or promoters of an event, activity, place, etc.;
      each category of users may interact with the service platform in a different way and be provided with a different set of functions or features;
In some embodiments, users of either category interested in space-based social networking may download an application and install it on their client-side device (such as a smartphone, laptop, tablet, etc.);
   Potential users may use the application to register for an account on the server/platform managing the space or place-based social network(s);
   In some embodiments, potential users may navigate to a website and register for an account;
In one example use case, user(s) who are visitors or participants (or potential visitors or participants) may capture or create content relevant to a space, place, event, activity, etc. and upload (post) that content to the server/platform using the application or by navigating to the website;
   The user may “tag” or associate the content with an identifier (e.g., #museum);
      The tag may include a reference to a place, space, location, event, experience, activity, etc.;
      If a webpage corresponding to the space, place, event, activity, etc. has already been created, then a user may find it using a search function using its name (or other characteristic, such as location or descriptive term) and post the content to the webpage;
         In some embodiments, a user may access a map and use that to identify a location or region of interest, with the server/platform proving a list of events, cultural categories, activities, etc. that are available within the identified area or region;
         A user may enter their preferred type of cultural event in a profile maintained as part of their account so that places, spaces, events, activities, etc. that are expected to be of interest to the user can be listed or prioritized and presented to the user;
         In some embodiments, a recommendation process may be incorporated, that operates to recommend a cultural space, event, or activity that it is expected to be of interest to a user;
         In one embodiment, the recommendation process may incorporate a trained model that “learns” based on the user's previous usage of the server/platform, and/or that of other users who visit the same space or place-based social networking sites or pages as the user (a form of collaborative filtering, for example);
      If a webpage corresponding to the space, place, event, activity, etc. has not yet been created by the server/platform, then a user may perform the posting function through the downloaded application;
         in some embodiments, this will result in creation of a corresponding webpage, and if not it will result in storage of the post(s)/content for later association with a webpage when one is created;
         in some embodiments when the number of user searches for a place, space, etc. reaches a pre-determined level, a corresponding webpage may be created automatically by the server/platform—in some embodiments, the webpage may not be created until the number of posts reaches a threshold amount or threshold number of different sources (posters);
         in some embodiments, the operator of the system/platform may contact an administrator or organizer of an event or activity, owner of a place or space, or advertiser or promoter of an event, activity, or place in response to the platform receiving content from interested users and suggest the creation of a space or place-based social networking webpage (or website);
In another example use case, an administrator or organizer of an event or activity, owner of a place or space, or advertiser or promoter of an event, activity, or place may contact the operator of the server/platform to register and create an account, followed by creating a webpage or website to promote an event, encourage users to post content and/or inquire about the place, space, etc.;
The place or space-based webpage (or website) may include user interface components and tools to enable viewers of the webpage to post content, evaluate content, and engage in communications with each other (e.g., text, messages, images, video, etc.);
   Thus, users of the application may access a webpage created for or corresponding to a space, place, event, or activity and share content and/or communicate with others having a similar interest;
      This may be done without users having a previous relationship or being connected to each other, as in conventional social networks;
      Such a space or place-based social network also permits users to interact with others while maintaining a greater degree of control over their privacy and personal information than conventional social networks, as posted content is not about a user but relates to a space, place, event, etc.;
         Although a conventional social network may include an ability to create a “group” page based on a shared hobby or interest, in such networks, it is not the case that a space or place-based web page serves as a fundamental “unit” or the basis of an account. In some embodiments, a unit of the platform disclosed herein is a space or place where events are held, so users can evaluate various events, activities, and spaces;
         For example, users may “rate” a space by clicking a “like” button or mark a star-rating after navigating to space or place the webpage;
         The disclosed platform and associated features can enable a form of competition between spaces/places by providing viewers with the number of “likes” or average star rating of each webpage and ranking the webpages according to a metric or category—the most popular sites (representing places, spaces, activities, etc.) can be identified from the ranking/metric and presented in a prioritized list based on segmenting individual users or user-expressed preferences;
         In a conventional social network platform, even if there are webpages based on hobbies or interests, the platform does not compare, evaluate, or analyze those webpages in terms of the functions and features of the platform because it is an individual's account or webpage that serves as the fundamental unit of the platform;
A function associated with a space-based webpage, or the operator of the server/platform may contact an owner or operator, a promoter, or advertiser for the space, place, event, or activity to suggest they post an offer, coupon, advertisement, suggestion, etc. to the viewers of the webpage;
   This may occur automatically and be based on the popularity of a space-based webpage (such as the number of posts, number of views, etc.);
The server/platform operator may offer access to the space-based social network to entities associated with a space, place, event, or activity under one or more business arrangements;
   Subscription basis to allow communications with users of the webpage who have expressed an interest in the space, place, etc.;
   Transaction fee basis for each transaction between a user visiting a webpage hosted by the server/platform and an owner or operator, a promoter, or advertiser for a space, place, event, or activity;
   Providing a package of events or category of events to users with a fee for distribution paid by an owner or operator, a promoter, or advertiser for a space, place, event, or activity;
In some embodiments, the server/platform operator may facilitate transactions between users/viewers or between users and an owner or operator, a promoter, or advertiser for the space, place, event, or activity. As non-limiting examples, these transactions may include:
   Ticket sales;
   Added-value services, such as special content created by one user to be sold to another;
   Packages of events or activities;
   Payment processing services; or
   Hosting special events at the space or place, or in coordination with an event or activity.

As described, although in one example implementation one or more users interested in a space, place, event, or activity may initiate a process of establishing a space-based social network, another implementation is one in which an administrator or “host” of an event or activity initiates a process to enable the formation of a space-based social network focused on the event or activity by contacting an operator of the system/platform described herein. This may include enabling interested persons to download the described application or plug-in from a webpage associated with the space, place, event, or activity.

Allowing interested members of the public to assist in creating a space or place-based account is beneficial because it helps the platform gain traction prior to it becoming more widely known. Typically, an event host (or space or place owner, etc.) accesses a platform and creates an account voluntarily; however, this is realistic only after the market becomes sufficiently aware of the platform and its membership. Therefore, embodiments provide a technique that allows general users (i.e., place visitors or event participants) to contribute to creating an account for a space, a place, an event, an activity, etc. This assists in more space or place-based accounts being created by enlarging the user base that can create accounts. Further, this alternative process benefits both members of the public interested in a space, place, event, or activity, as well as a host, owner, or operator, as it indicates a level of interest and may lead to more effective marketing, enlarged participation, or new features at an event, among other benefits.

In one embodiment, the disclosure is directed to a system for forming and using a social network based on a space, place, or event. The system may include a set of computer-executable instructions and an electronic processor or co-processors. When executed by the processor or co-processors, the instructions cause the processor or processors (or a device of which they are part) to perform a set of operations that implement an embodiment of the disclosed method or methods.

In one embodiment, the disclosure is directed to a set of computer-executable instructions, wherein when the set of instructions are executed by an electronic processor or co-processors, the processor or co-processors (or a device of which they are part) perform a set of operations that implement an embodiment of the disclosed method or methods.

Other objects and advantages of the systems and methods described will be apparent to one of ordinary skill in the art upon review of the detailed description and the included figures. Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the forms disclosed. Rather, the present disclosure covers all modifications, equivalents, and alternatives falling within the scope of the appended claims.

### BRIEF DESCRIPTION OF THE DRAWINGS

Embodiments of the system and methods in accordance with the present disclosure will be described with reference to the drawings, in which:

FIG. 1(a) is a diagram illustrating elements, components, or functionality of a place or space-based social networking system that may be used in implementing an embodiment of the disclosure;

FIG. 1(b) is a flowchart or flow diagram illustrating a method, process, operations, or set of functions that may be used in implementing an embodiment of the disclosure;

FIG. 1(c) are diagrams illustrating some of the differences between conventional social networks and an embodiment of the place or space-based social network described herein;

FIG. 2 is a diagram illustrating elements or components that may be present in a computer device or system configured to implement a method, process, function, or operation in accordance with an embodiment of the system and methods described herein;

FIG. 3 is a diagram illustrating a clustering architecture that may be used in implementing an embodiment of the disclosure;

FIG. 4 is a diagram illustrating elements or processes that may be part of a cluster that is part of the architecture illustrated in FIG. 3; and

FIGS. 5-7 are diagrams illustrating a deployment of the system and methods described herein as a service or application provided through a Software-as-a-Service platform, in accordance with some embodiments.

Note that the same numbers are used throughout the disclosure and figures to reference like components and features.

### DETAILED DESCRIPTION

The subject matter of embodiments of the present disclosure is described herein with specificity to meet statutory requirements, but this description is not intended to limit the scope of the claims. The claimed subject matter may be embodied in other ways, may include different elements or steps, and may be used in conjunction with other existing or later developed technologies. This description should not be interpreted as implying any required order or arrangement among or between various steps or elements except when the order of individual steps or arrangement of elements is explicitly noted as being required.

Embodiments of the disclosure will be described more fully herein with reference to the accompanying drawings, which form a part hereof, and which show, by way of illustration, exemplary embodiments by which the disclosure may be practiced. The disclosure may, however, be embodied in different forms and should not be construed as limited to the embodiments set forth herein; rather, these embodiments are provided so that this disclosure will satisfy the statutory requirements and convey the scope of the disclosure to those skilled in the art.

Among other things, the present disclosure may be embodied in whole or in part as a system, as one or more methods, or as one or more devices. Embodiments of the disclosure may take the form of a hardware implemented embodiment, a software implemented embodiment, or an embodiment combining software and hardware aspects. For example, in some embodiments, one or more of the operations, functions, processes, or methods described herein may be implemented by one or more suitable processing elements (such as a processor, microprocessor, CPU, GPU, TPU, controller, etc.) that is part of a client device, server, network element, remote platform (such as a SaaS platform), an “in the cloud” service, or other form of computing or data processing system, device, or platform.

The processing element or elements may be programmed with a set of executable instructions (e.g., software instructions), where the instructions may be stored on (or in) one or more suitable non-transitory data storage elements. In some embodiments, the set of instructions may be conveyed to a user through a transfer of instructions or an application that executes a set of instructions (such as over a network, e.g., the Internet). In some embodiments, a set of instructions or an application may be utilized by an end-user through access to a SaaS platform or a service provided through such a platform.

In some embodiments, one or more of the operations, functions, processes, or methods described herein may be implemented by a specialized form of hardware, such as a programmable gate array, application specific integrated circuit (ASIC), or the like. Note that an embodiment of the inventive methods may be implemented in the form of an application, a sub-routine that is part of a larger application, a “plug-in”, an extension to the functionality of a data processing system or platform, or other suitable form. The following detailed description is, therefore, not to be taken in a limiting sense.

In some embodiments, the systems and methods described herein provide space or place-based social networking services through a SaaS or multi-tenant platform. The platform provides access to multiple entities, each with a separate account and associated data storage. Each account may correspond to an individual user, a space, place, event, or activity, a group of such entities, or another business entity, for example. Each account may access one or more services, an example of which are instantiated in their corresponding account and which implement one or more of the methods or functions described. In some embodiments, each account may correspond to an end user (such as a visitor to a space or place, or a participant in an activity), with a group of accounts being accessible from a master account associated with a space, place, event, or activity.

Embodiments are directed to systems, devices, and methods for forming and using a social network based on a space, place, event, activity, location, experience, etc. The described approach provides several advantages compared to conventional social networks. These include but are not limited to overcoming the typically wide but shallow relationships formed using existing social networks through a place or space-based social network system. A place or space-based social network connects users who share interest in the same space, place, event, activity, etc. and enables the creation of more meaningful relationships based on and related to the shared interest.

An advantage of the systems and methods described is to provide a service based on a space (or place, event, activity, etc.) in which people having the same interest can form a social network through communication with each other about their shared interest. This is in contrast to responding to randomly posted content by people they may not know well, as is common with conventional social networks. Another advantage is by providing an ability for a caretaker, owner, promoter, or advertiser for a space, place, event, activity, etc. to directly connect and present content to people who have shown an interest in the space, place, etc. and who are more likely to respond favorably to presented content. The presented content is more likely to be of interest to a viewer and less likely to be the result of a model or algorithm that attempts to gauge a viewer's interest.

In some embodiments, people may download an application after visiting a space or place-based social networking service provider website because they want to be part of space-based social networking activities. They then engage in activities they enjoy (such as, but not limited to museums, restaurants, concerts, site-seeing, etc.) and use the application to post content. The application back-end server(s) receive and process the posts and may execute a logic process to decide when to attach a tag or create a webpage corresponding to a space, place, event, or activity. The back-end platform or server hosts the webpage and may contact the space, event, etc. to develop ways to monetize the value of the people engaging in communications and posting content (such as images, videos, comments, etc.) on the webpage for the space, place, etc.

In some embodiments, people may download an application after visiting a website hosted by an administrator or organizer of an event or activity that has arranged with a space or place-based social networking service provider to assist the administrator or organizer to establish and manage a space or place-based social network focused on the event or activity.

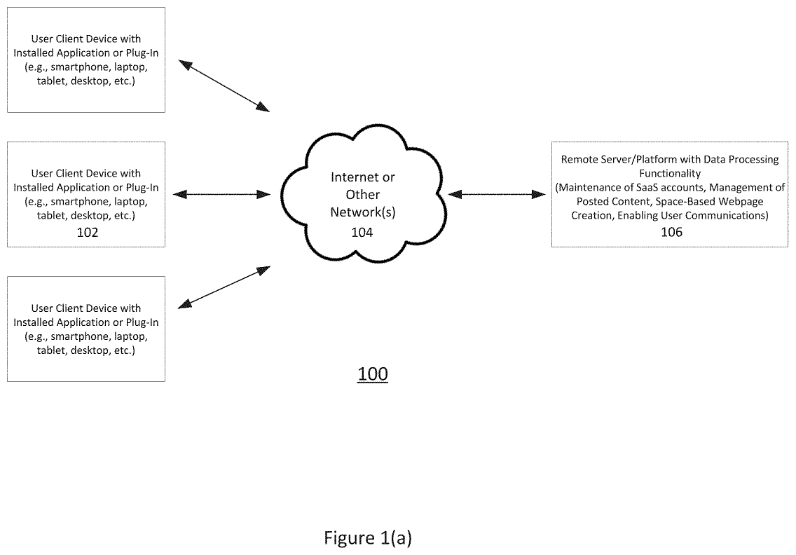

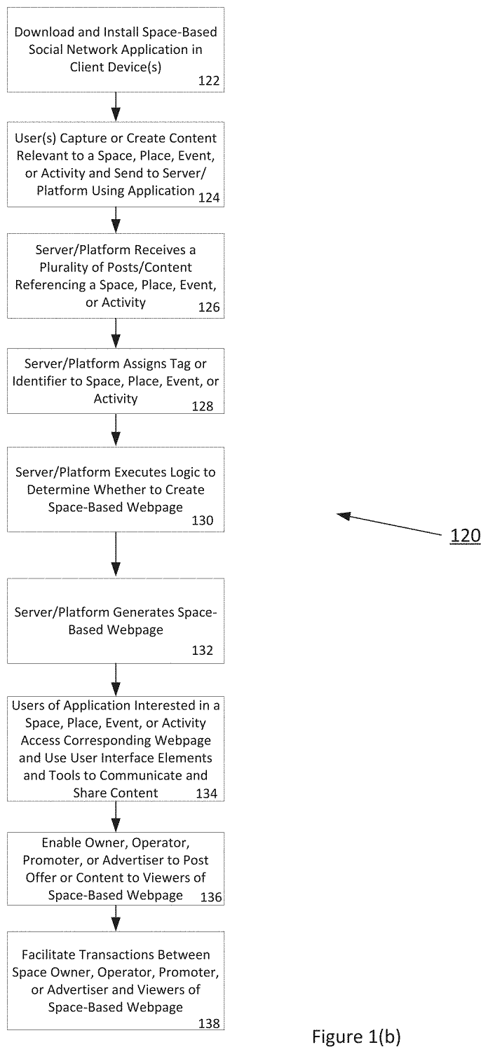

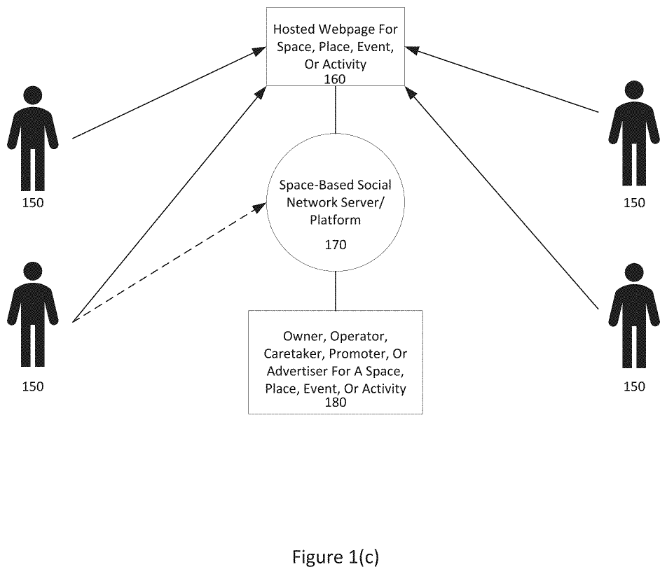

FIG. 1(a) is a diagram illustrating elements, components, processes, or functionality of a place or space-based social networking system 100 that may be used in implementing an embodiment of the disclosure. As shown in the figure, a user terminal 102 may communicate with the space-based social network system 100 through a network 104. The space-based social network system 100 may include a computing device that provides a service, such as a server or platform 106. Server or platform 106 may host a set of accounts and function as a Software-as-a-Service (SaaS) platform. In some embodiments, each account may correspond to or be associated with a space, place, event, or activity and may be configured with an instantiation of one or more processes, services, or applications.

In some embodiments, the instantiated services or applications may comprise one or more of:
a process or service to enable users interested in space-based social networking to download an application (or in some embodiments, a browser plug-in) and install it in their client-side device;
   where the application provides functions or capability for a user to capture or create content relevant to a space, place, event, or activity and send (post) that content to a back-end server or platform;
a process or service to enable the server/platform to receive a plurality of posts referencing a space, place, event, or activity from one or more users:
   in one embodiment, the server/platform may assign or associate a “tag” or identifier with the received posts, with the tag or identifier referencing the space, place, event, or activity;
      in one embodiment, the tag or identifier may be generated automatically based on use of:
         an image or object recognition technique (e.g., an image classifier, Convolutional Neural Network (CNN);
         such a technique may be used to identify a location, structure, event, etc.;
         a trained Machine Learning (ML) model;
         a text or character recognition technique;
         a Natural Language Processing (NLP) technique; or
         a Natural Language Understanding (NLU) technique;
      in one embodiment, a space or place owner, event promoter, or activity organizer (or other content provider) may provide content or may modify or process submitted content to make the content more accessible or more effective at marketing a space, place, event, or activity (where such modification or processing may include generating 3-dimensional images or video experiences, generating virtual or augmented reality presentations, etc.);
   a user posting content may be provided with a search function to enable determining if a webpage or data storage for a specific space, place, event, or activity presently exists;
      if no such webpage already exists and is being hosted by the server/platform, then a user may assign a “tag” or identifier to their content and the server/platform may either store the content or create a webpage on the back-end server/platform;
in some embodiments, a process or service that executes logic to determine whether to create a space-based webpage associated with a space, place, event, or activity may be executed upon receipt of content that is associated with a specific space, place, event, or activity;
   the executed logic may create the space-based webpage when the number of posts reaches a threshold amount or threshold number of different sources (i.e., posters);
   if created, the space-based webpage may include user interface components and tools to enable viewers of the webpage to post content, evaluate content, and communicate with each other (e.g., using text, messages, images, video, etc.);
a process or service to enable the space-based webpage or the operator of the server/platform to contact an owner or operator, a promoter, or advertiser for the space, place, event, or activity to suggest they post an offer, coupon, advertisement, suggestion, etc. to the viewers of the webpage;
a process or service to enable the server/platform operator to offer access to the space-based social network to entities associated with a space, place, event, or activity under one or more business arrangements or revenue sharing or revenue generating models; and
a process or service to enable the server/platform operator to facilitate transactions between users/viewers and the owner or operator, a promoter, or advertiser for the space, place, event, or activity;
   in some embodiments, a process or service may enable or facilitate transactions between users, such as for exchange of content, generation of requested content, arranging events, etc.;
once created a space or place-based social network webpage or website may include user interface components and tools to enable viewers of the webpage to post content, evaluate content, and engage in communications with each other (e.g., text, messages, images, video, etc.).

In one embodiment, network 104 may comprise components or elements capable of exchanging data and information with each other, such as a plurality of terminals and servers. Examples of such a network include the Internet, a 3rd Generation Partnership Project (3GPP) network, LTE (Long Term Evolution) network, 5G network, WIMAX World Interoperability for Microwave Access) network, Internet, LAN (Local Area Network), Wireless LAN (Wireless Local Area Network), WAN (Wide Area Network), PAN (Personal Area Network), Bluetooth (Bluetooth) network, satellite broadcasting network, analog broadcasting networks, Digital Multimedia Broadcasting (DMB) networks, and the like.

User terminal(s) 102 may comprise a wireless communication device that provides portability and mobility, or a computing device (such as a tablet or laptop computer) and may include or be connected to a camera. Examples include a Personal Communication System (PCS), a Global System for Mobile communications (GSM), PDC (Personal Digital Cellular), PHS (Personal Handyphone System), PDA (Personal Digital Assistant), IMT (International Mobile Telecommunication)-2000, CDMA (Code Division Multiple Access)-2000, W-CDMA (WCode Division Multiple Access), a Wibro (Wireless Broadband Internet) terminal, a smart phone, a smart pad, a laptop or tablet PC, etc. and may include other kinds of handheld or portable wireless communication devices.

As mentioned, a process or service executed by server/platform 106 may manage information in a post associated with a space, place, event, activity, etc. by assigning or associating it with a tag or other form of identifier (which may be provided with the posted content). The tag or other form of identifier may reference the space, place, event, or activity (such as #space name, #event name, etc.). The space, place, event, or activity may comprise one or more of an individual store, a city, a cultural or artistic space, a concert or play, a location, a natural or human-made feature (such as a mountain, river, lake, waterfall, etc.) and be presently existing or be planned. As non-limiting examples, a specific space may be an individual store such as a cafe or restaurant, a city such as Paris, Seoul, or Tokyo, or it may be a cultural or artistic space where cultural events are held (such as a concert hall, exhibition hall, museum, or sports stadium).

According to an embodiment, a posting management process executed in (or by) server or platform 106 may manage information about a post uploaded by a person or process. The posting management may include using or assigning a tag or identifier for a specific space, place, event, or activity. Information (or metadata) associated with a post may include at least one of text, image, video, and location information for a post related to a specific space, place, event, or activity. The text may include text entered by the user through the user's device 102.

A webpage generation process executed in (or by) server or platform 106 may generate a webpage for a space, place, event, or activity. The generated webpage may be associated with the corresponding tag or identifier. The webpage may be provided to the user device 102 to be displayed on a screen of the device. In some embodiments, the webpage or elements of the webpage may be displayed or presented using a virtual reality or augmented reality device or technique. The generated webpage may include at least a portion of a post uploaded using a tag/identifier and/or information about the post.

In some embodiments, and if available to a user, content may be displayed using a functionality that operates to “cast” or otherwise transfer content from a user's device to a larger screen, such as a television or video display. In these embodiments, the application downloaded and installed in a user device may incorporate the ability to wirelessly connect to a television or other device and transfer content to that device. This could be used as part of live-casting an event to allow multiple people to view the content and in some cases interact with it, such as by participating in a game or task.

Content generated by users of space-based social networks can be viewed locally on televisions and/or on larger screens installed in public places (such as media walls). This can be very effective in creating and encouraging membership in a space or place-based social network, as an event relayed through a live cast or content that can be viewed using VR/AR tools becomes more immersive as the screen size increases. This can contribute to enhancing the user experience well beyond what is available through a conventional social network.

Users who have uploaded a post using a tag or identifier for the same space, place, event, or activity may access the space-based webpage through their respective user devices. The space-based webpage can be accessed or used by users who have uploaded content using tags/identifiers and by users of the application who have not uploaded content or posted comments but are interested in the space, place, event, or activity.

The generated webpage (or website) may include a chat window or a communication service user interface. The chat window or communication service user interface and capabilities may be provided to a device and/or used with the assistance of a virtual reality or augmented reality technique or method. The communication service user interface may enable communication between viewers or visitors to a space-based webpage using text, email, voice, image, or video. Thus, in accordance with one or more embodiments, a chat window or communication service user interface may be provided to a group having a common interest in a particular space, place, event, or activity, and who therefore are more likely to have subjects to discuss and a willingness to engage in interactions with others they do not know. This is different than a single person posting to their own network of “friends” as part of a conventional social network.

In some embodiments, the space-based social network system 100 may further include a search function or capability that provides a user with the ability to search for a specific space, place, event, or activity to either post content or view and interact with posted content. The search may enable a user to enter a keyword or “tag”, identify a location or region of interest, or identify a topic or category of interest (such as museum, art gallery, park, theater, etc.).

FIG. 1(b) is a flowchart or flow diagram illustrating a method, process, operations, or set of functions 120 that may be used in implementing an embodiment of the disclosure. As shown in the figure, in this embodiment, at step or stage 122, persons interested in participating in (or with) a space-based social network may download and install an application in their client device(s). A person's device may be a mobile phone equipped with a camera, a laptop computer, a tablet computer, or a desktop computer, as examples.

In this example embodiment, one or more users may capture or create content relevant to a space, place, event, or activity and send/upload the content (herein referred to as “posting” and which may be text, an image, or video) to a remote server or platform with which the downloaded application communicates (as suggested by step or stage 124). The server/platform receives one or more such posts that reference a specific space, place, event, or activity, as suggested by step or stage 126. Note that the server/platform may receive one or more posts for each of a plurality of spaces, places, events, etc.

The server/platform may assign a tag or other form of identifier to the space, place, event, or activity (e.g., #space, #place, #event name, etc.) for which it has received one or more posts of content, as suggested by step or stage 128. The assigned tag or identifier may be generated by a user or by the server/platform. If assigned by the server/platform, the identifier may be generated and assigned after execution of logic that determines if sufficient interest has been shown in a space, place, event, or activity (such as in response to the server/platform receiving a threshold number of posts for the space, place, etc., or a threshold number of posts from different sources).

Prior to (or after) assigning the tag or identifier, the server/platform may execute logic to determine whether to create a space-based webpage or website for the space, place, event, or activity, as suggested by step or stage 130. The logic may make the determination based on consideration of one or more parameters or characteristics, including but not limited or required to include:
the number of posts referencing the space, place, event, or activity;
the number of different users posting content relevant to the space, place, event, or activity;
the terms of an agreement with an operator, owner, or promoter of a space, place, event, or activity; or
other indicia of interest in the space, place, event, or activity (such as posts to another social network, news articles, newsletters, other advertisements, etc.);
   in one embodiment, a trained machine learning model may assist in determining if sufficient interest has been shown or is likely to exist in a space, place, event, or activity based on one or more sources, such as received posts, advertisements, social media, etc.

In one embodiment, if the executed logic does not result in assignment of a tag or identifier or does not result in the creation of a space-based webpage or website for the space, place, event, or activity, then the content posted may be stored in a way that associates the content with the subject of the post(s) for later access and use by the server/platform when deciding whether to assign an identifier and/or create a webpage or website.

In some embodiments, a user may execute a search process to determine if the space, place, event, or activity they are interested in has already had a webpage created and/or tag or identifier assigned. If it has, then the user may be directed to that webpage and allowed to post content and/or interact with posted content. If such a webpage has not been created, the user may be provided with tools to post content and associate it with a tag or identifier. In some examples, this may lead to the creation of a webpage and if not, the content and identifier may be stored by the server/platform and used when a webpage is created.

If after executing the described logic, a determination is made to generate the space-based webpage, then the server/platform generates and hosts the webpage, as suggested by step or stage 132. The webpage may include user interface elements and tools or functionality to enable a viewer or visitor to the webpage to post content and to communicate/interact with other viewers or visitors using one or more communication methods, including but not limited to or required to include text, email, chat, images, or videos.

Users of the downloaded application interested in a space, place, event, or activity may navigate to the webpage (e.g., by using a search function accessible through the application, by entering a webpage address, tag, or identifier at a website “home” page hosted by the server/platform, or other suitable method) and post content and/or communicate with others who are similarly interested in the space, place, event, or activity, as suggested by step or stage 134.

Embodiments of the system and methods for creating a space or place-based social network enable interactions between members or participants in the network in a different manner than conventional social networks. In a conventional social network, people join the network and then create a sub-network of their selected friends and/or contacts. This creates a plurality of one-to-one relations, followed by allowing a person who is part of the sub-network to post content that can be viewed by others in the sub-network. Conventional social networks enable users to “connect” with a set of people (typically requiring that the person “invited” to connect accept the invitation), and then interact with those with whom they are connected.

In contrast, the disclosed system and methods operate or function to create a webpage or website that interested persons become “connected” to, and then provide tools to enable those persons to interact with each other by posting content viewable by others who access the webpage or website. Thus, in the disclosed system and methods, individual users are not “connected” to each other by the social network, but instead to a place, event, etc. It is the connection to the place, event, etc. that enables interactions as opposed to a connection to another person.

In one sense, a conventional social network functions as a replacement or alternative for the way a telephone might be used—to connect individuals and provide a conduit for transferring information. A space or place-based social network instead creates a gathering place for previously unconnected individuals who share an interest and may or may not exchange information. As such, the architectures constituting the network are different, and the functions and features implemented are different.

Space or place-based social networks allow for more cohesive conversations because they have a common theme: a space, or an event or activity held in a space or at a location. Because it is space or place-based, embodiments can more effectively implement desirable aspects of a VR/AR experience or environment. However, although some VR/AR experiences or environments may be limited to virtual spaces (such as a virtual universe), the space or place-based social network disclosed is a system in which the virtual world and the real world (i.e., existing places and events) are connected and can be interacted with by users.

In some embodiments, an owner, operator, caretaker, promoter, or advertiser for a space, place, event, or activity may desire to contact members of a space-based social network to offer them a discount, coupon, invitation, suggestion, post content, etc. The server/platform may enable this by providing a mechanism for such an entity to contact, communicate, or post content (such as incentives, advertisements, offers, etc.) to viewers of a space-based webpage, as suggested by step or stage 136. This ability may be provided in return for a fee, subscription payment, revenue sharing, or other type of agreement in which access to the space-based social network members and associated webpage is provided as part of a business arrangement that generates revenue for the operator of the server/platform hosting a space-based social network.

In some embodiments, a webpage or website associated with a space, place, event, or activity may be created and hosted by the server/platform in response to a request by an owner, operator, caretaker, promoter, or advertiser. In these embodiments, the owner, operator, caretaker, promoter, or advertiser may direct interested persons to the webpage or website and thereby allow them to become part of the space or place-based social network.

In some embodiments, the server/platform may facilitate transactions between an owner, operator, caretaker, promoter, or advertiser for a space, place, event, or activity and a user of the application who is viewing or visiting the space-based webpage, as suggested by step or stage 138. This may comprise payment processing, e-ticketing, purchase of added-value packages, or otherwise facilitating a transaction, including peer-to-peer transactions such as transferring content, requesting specific content relevant to a space, place, etc.

FIG. 1(c) is a diagram illustrating relationships between users and certain of the elements or components of an embodiment of the place or space-based social network described herein. As shown in the diagram, one or more users 150 interact with a hosted webpage or website 160 for a space, place, event, or activity. Webpage or website 160 is hosted and maintained by space-based server/platform 170. The operator of space-based server/platform 170 and/or an administrator 180 associated with the owner, operator, caretaker, promoter, or advertiser for a space, place, event, or activity may be granted access to a specific webpage or website and be able to modify content, control access, communicate with users 150.

As described, differences between a conventional social network and a space-based social network include, but are not limited to:
in the case of conventional or traditional social networks, connections occur based on a person's social page, while a space-based social network causes people to gather on a place's social page and interact with each other based on their common interest;
   in contrast to a conventional social network in which the network is formed from a plurality of people who join the network and then discover or make “friends”, a space- or place-based social network centers on a location, event, etc. and represents an interest in the location or event;
      Although a conventional social network may include an ability to create a “group” page based on a shared hobby or interest, in such networks, it is not the case that a space or place-based web page serves as a fundamental “unit” or the basis of an account. In some embodiments, a unit of the platform disclosed herein is a space or place where events are held, so users can evaluate various events, activities, and spaces;
         For example, users may “rate” a space by clicking a “like” button or mark a star-rating after navigating to a space or place webpage;
         As mentioned, in the context of the disclosure, the basic component or “unit” of a social network platform is a space, place, event, or activity. In a conventional social network, the basic component of interactions is the individual, and this component is relevant to creating a webpage or presence in the network, serving as a target of a search, being the purpose and result of establishing a connection, and being the target or object of platform features and functions;
         In contrast, for a space or place-based social network as disclosed herein, the basis of these activities is a space, place, event, or activity. A space-based social network is focused on a space, place, event, or activity and the user interface and user experience are designed to provide a sense of space and three-dimensionality. For example, use of a map to give a sense of space, and a live-cast of an event that connects users on site and those not present are features that may be used to induce collective activities between users and contribute to creating a sense of a space or location;
      The disclosed platform and associated features can enable a form of competition between spaces/places by providing viewers with the number of “likes” or average star rating of each webpage and ranking the webpages according to a metric or category—the most popular sites (representing places, spaces, activities, etc.) can be identified from the ranking/metric and presented in a prioritized list based on segmenting individual users or user-expressed preferences;
         In a conventional social network platform, even if there are webpages based on hobbies or interests, the platform does not compare, evaluate, or analyze those webpages in terms of the functions and features of the platform because it is an individual's account or webpage that serves as the fundamental unit of the platform;
   space-based social network users who gather on a place's social page are understood to have shared interests and the structure of the application and user experience fosters more intensive conversation(s) between users and hosts or caretakers of the place, activity, or event;
      More cohesive conversations due to a shared interest:
         in one sense, a space or place-based social network is similar to providing a prompt or topic to users who access the site (e.g., a specific play or plays in general for a theater site, a baseball game or baseball in general for a sports stadium site, etc.). This is a difference from conventional social networks based on connections between individuals where no topic is associated with a webpage other than what the individual chooses to post or comment upon;
         in a conventional social network, the lack of a common topic results in fragmented interactions and conversations. In a space or place-based social network, a more cohesive conversation is possible because there is a common topic of conversation between users. For example, a chat window can be created focusing on a topic related to an event or place, and participants can participate in the chat window by selecting a desired topic;
      More cohesive activity driven by a space or place-oriented focus:
         in a space or place-based social network, various features or functionality can be presented based on a specific place. For example, group activities such as finding a hidden treasure in a specific place, answering quiz questions, or solving a puzzle related to a specific place are possible. Since it is place-based, VR and AR can be utilized very effectively to engage users;
since the space-based social network is a place-based form of social media, its VR and AR experience is expected to be stronger than that of other social media, as the VR and AR will relate to a physical space, place, event, or activity and be more relevant and immersive; and
instead of a network formed by connections between pairs of people, a space-based social network is formed from connections between a set of people and a single space or place related webpage representing a space, place, event, or activity.

In addition to the features, functions, and capabilities described, embodiments may enable or otherwise support the following:
A user at a location, place, event, etc. may use 360-degree view cameras, wearable cameras, or an advanced recording device to live-cast an event, activity, experience, etc. through the space or place-based social network platform 170 so that others who are not at the location can enjoy the events in real-time (subject to any restrictions imposed by event organizers);
Users 150 connected to a space, place, event, etc. (by virtue of accessing webpage or website 160) may be enabled to perform collective actions through platform 170 on a real-time basis (e.g., gaming activities, games based on identifying aspects of the space or place, etc.);
Note that use of platform 170 and its functionality is not limited to mobile phones. Users can use the platform in conjunction with other devices, including but not limited to tablets, laptops, and TVs through a casting function of their smartphone.

Server/platform 170 may provide an owner, operator, caretaker, promoter, or advertiser 180 for a space, place, event, or activity to perform functions needed to create/host a webpage and interact with visitors or viewers of that webpage. These “functions” may include, but are not limited to:
Enable an event manager, communications manager for an event or facility, etc. to access their account to alter or manipulate the webpage content, prepare a communication with a member or members of the social network, assist in curating content, etc.;
For example, by generating a user interface that permits a person to create a web page or alter an existing web page by providing content describing an event, location, facility, performer, exhibit, etc.;
Further, the functionality of server/platform 170 may enable a person to search for an event s/he is interested in or a venue where the event is occurring (e.g., providing a customized search according to genres, locations, experiences, categories, dates, times, ticket availability, reviews, subject matter, etc.) and “join” the social network directed to the event, performer, experience, location, or venue.

In some embodiments, in addition to or instead of content submitted by persons interested in a space, place, event, or activity, a source or sources for information pertaining to a space, place, event, or activity and its presentation may include, but are not limited to:
Fetching of data by the server/platform from an event API provider. This would allow cultural events from around the world (depending on the categories requested) to be made available to the system;
Once signed in, a user may be presented with visual images (e.g., a movie style poster or other representation) of a space, place, event, activity, location, performer, or venue (typically including an event title, date/time, and place) and the user interface may allow a “swiping” motion to indicate interest or lack of interest by a user;
   By tapping on an image they are interested in, a user can be taken to the specific space, place, event, activity, location, performer, or venue's page. On that page, a user can find content created and uploaded by a promoter about the specific event, venue, etc.;

Note that in the absence of the data being made available through an API, a platform operator would need to contact a large set of event organizers and venues and ask them to provide access to their own account/page, to make their event information available to users. Note also that once the service platform develops a reputation and is well enough known to the public, the platform operator may request participation from event organizers to benefit the platform, users, and the organizers to increase knowledge of, and participation in, events.

Possible Sources of Revenue Based on Space-Based Social Networking

There are multiple potential streams or sources of revenue that may be generated using an embodiment of the space-based social network system and methods described herein. These include but are not limited to those described in the following sections.

Subscription Fees

The client device application or plug-in and server/platform functionality are used to create a space or place-based social network, from which an entity owning or managing a space, place, event, or activity may derive revenue. A source of revenue for the operator of the server/platform is a regular subscription fee from these entities or others who may derive a benefit from the existence of a space or place based social network. This may include clubs or organizations seeking new members, employers, unions, social clubs, sports teams, governmental entities, etc.

For example, a venue for a cultural event, such as Carnegie Hall, NYC, Sydney's Opera House, or the Louvre Museum in Paris may be associated with a respective space or place-based webpage that is hosted by the disclosed platform. The operator of the server/platform may receive a monthly subscription fee for providing that entity with access to an administrative console. The console may enable the space or place owner/operator to more efficiently market to interested viewers by providing access to data about people visiting the associated space or place-based webpage. This information (which may include demographic, sentiment, keywords, user suggestions, etc.) may be used to segment viewers of a page for purposes of more focused marketing, increase conversion rates so that a greater number of page viewers visit a space or place, purchase a ticket to an event, or participate in an activity.

As an example, event organizers can upload information about an event, promote the event, and invite participants. The benefits of viral marketing for an organizer can be made available through contact with people gathered on a webpage for a specific space, place, event, or activity. This can be an effective marketing medium for events such as gatherings at local bookstores, exhibitions of self-drawn paintings, wine tasting, and soccer matches for office workers, as examples.

E-Ticketing Transaction Fees

Another business model that may be used is to sell e-tickets for users to be able to visit places or events described on a webpage of the space-based social network. The e-ticket may be offered at a reduced rate compared with its offline ticket or admission fee at the actual place or event. The server/platform operator may earn a commission from acting as a broker or intermediary for the purchase of an e-ticket.

Peer-to-Peer (P2P) Transactions

After the space or place-based social network system establishes a sufficient level of awareness in the global market, the operator of the server/platform may establish a P2P (peer-to-peer) system to allow individual users to offer and purchase space, place, event, or activity related content through the application. For example, individual users may exchange cultural content by engaging in a transaction and the server/platform operator may earn a commission from those transactions.

Added Value Modules

As the popularity and use of space or place-based social networks increases, users may desire additional functions or capabilities. These may be provided through added-value purchases that are installed as modules on a user's device or are accessible to an authorized user through a space or place webpage or website, and may include translation of content into other languages, tour guides for a location or event, bonus content, etc.

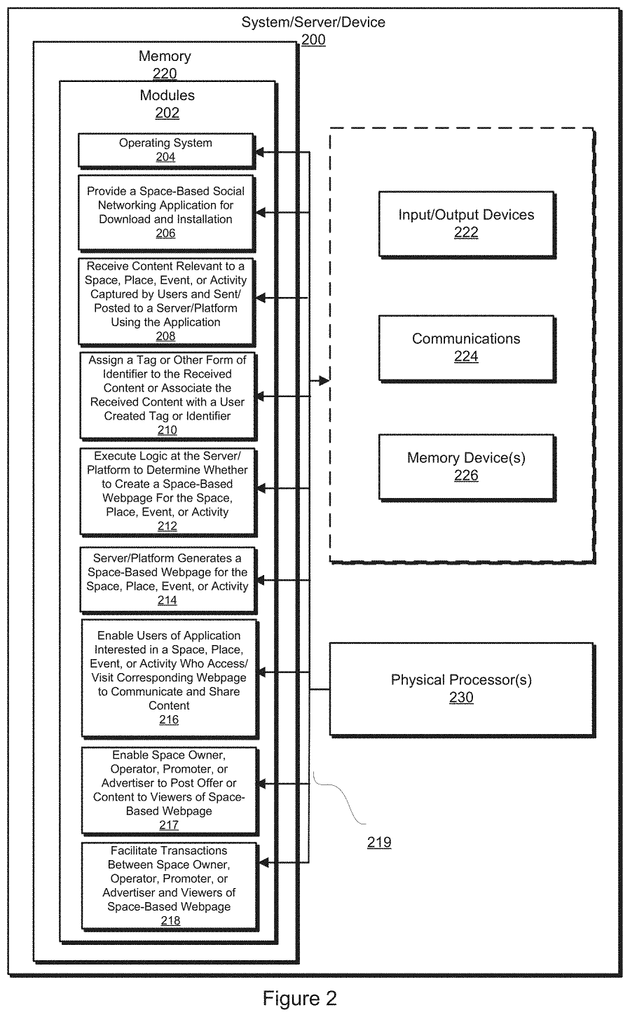

FIG. 2 is a diagram illustrating elements, components, or processes that may be present in or executed by one or more of a computing device, server, platform, or system 200 configured to implement a method, process, function, or operation in accordance with some embodiments. In some embodiments, the disclosed system and methods for creating and managing a space or place-based social network may be implemented in the form of an apparatus or apparatuses (such as a server that is part of a system or platform, a client device, etc.) that includes a processing element and a set of executable instructions. The executable instructions may be part of a software application (or applications) and arranged into a software architecture.

In general, an embodiment of the disclosure may be implemented using a set of software instructions that are designed to be executed by a suitably programmed processing element (such as a GPU, TPU, CPU, microprocessor, processor, controller, computing device, etc.). In a complex application or system such instructions are typically arranged into “modules” with each such module typically performing a specific task, process, function, or operation. The entire set of modules may be controlled or coordinated in their operation by an operating system (OS) or other form of organizational platform.

The modules and/or sub-modules may include a suitable computer-executable code or set of instructions, such as computer-executable code corresponding to a programming language. For example, programming language source code may be compiled into computer-executable code. Alternatively, or in addition, the programming language may be an interpreted programming language such as a scripting language.

As shown in FIG. 2, system 200 may represent a server, client device, platform, or other form of computing or data processing device. Modules 202 each contain a set of executable instructions, where when the set of instructions is executed by a suitable electronic processor (such as that indicated in the figure by “Physical Processor(s) 230”), system (or server, or device) 200 operates to perform a specific process, operation, function, or method.

Modules 202 may contain one or more sets of instructions for performing a method or function described with reference to the Figures, and the descriptions of the functions and operations provided in the specification. These modules may include those illustrated but may also include a greater number or fewer number than those illustrated. Further, the modules and the set of computer-executable instructions that are contained in the modules may be executed (in whole or in part) by the same processor or by more than a single processor. If executed by more than a single processor, the co-processors may be contained in different devices, for example a processor in a client device and a processor in a server.

Modules 202 are stored in a memory 220, which typically includes an Operating System module 204 that contains instructions used (among other functions) to access and control the execution of the instructions contained in other modules. The modules 202 in memory 220 are accessed for purposes of transferring data and executing instructions by use of a “bus” or communications line 219, which also serves to permit processor(s) 230 to communicate with the modules for purposes of accessing and executing instructions. Bus or communications line 219 also permits processor(s) 230 to interact with other elements of system 200, such as input or output devices 222, communications elements 224 for exchanging data and information with devices external to system 200, and additional memory devices 226.

Each module or sub-module may correspond to a specific function, method, process, or operation that is implemented by execution of the instructions (in whole or in part) in the module or sub-module. Each module or sub-module may contain a set of computer-executable instructions that when executed by a programmed processor or co-processors cause the processor or co-processors (or a device, devices, server, or servers in which they are contained) to perform the specific function, method, process, or operation. As mentioned, an apparatus in which a processor or co-processor is contained may be one or both of a client device or a remote server or platform. Therefore, a module may contain instructions that are executed (in whole or in part) by the client device, the server or platform, or both. Such function, method, process, or operation may include those used to implement one or more aspects of the disclosed system and methods, such as for:
Providing A Space-Based Social Networking Application for Download and Installation in Client Device(s) (as suggested by module 206);
   This may be provided directly through a download or indirectly by linking to an application storage element or a stored browser plug-in;
Enabling a Server/Platform to Receive Content Relevant to a Space, Place, Event, or Activity Captured by Users and Sent/Posted to the Server/Platform Using the Application (module 208);
   The content captured or created by a user may be uploaded to a server/platform using the installed application, or may be posted directedly to a webpage of an operator of the platform;
Assigning a Tag or Other Form of Identifier to the Received Content or Associating the Received Content with a User Created Tag or Identifier (module 210);
Executing Logic at the Server/Platform to Determine Whether to Create a Space-Based Webpage for the Space, Place, Event, or Activity (optional) (module 212);
   As described, in some embodiments, the executed logic may determine whether a threshold number of posts have been received or a threshold number of individual posters have provided content in deciding whether to create a space or place-based webpage;
   In some embodiments, the executed logic may determine if the provided content has one or more desired characteristics (such as format, resolution, presence of keywords, etc.) in deciding whether to create a space or place-based webpage;
Server/Platform Generates a Space-Based Webpage for the Space, Place, Event, or Activity (module 214);
   The generated webpage (or website) is hosted by the server/platform and nay be associated with an account for a specific space, place, event, or activity (or an owner or operator of one or more of those);
Enable Users of Application Interested in a Space, Place, Event, or Activity Who Access/Visit Corresponding Webpage to Communicate and Share Content (module 216);
   This may include by providing a user interface and set of tools to enable posting of content, communications with other users, and/or communications with an owner or operator of a space, place, event, activity, etc.;
Enable Space Owner, Operator, Promoter, or Advertiser to Post Offer or Content to Viewers of Space-Based Webpage (module 217);
   This may include generating recommendations to users based on data obtained through the server/platform and one or more of the hosted accounts/social networks using a trained model, rule-set, etc.; and
Facilitate Transactions Between Space Owner, Operator, Promoter, or Advertiser and Viewers of Space-Based Webpage (module 218);
   This may include providing a set of transactions that users can engage in with other users and/or an owner or operator, including ticket sales, discounted purchases, creation and distribution of content, packages of experiences;
   In some embodiments, this may include payment processing services.

Each hosted webpage or web-site serves as a location for members of a space or place-based social network to interact with each other and with an owner or operator of a space, place, event, activity, experience, etc. As described, each member first becomes “connected” to the space, place, etc. before interacting with other members of the social network. This contrasts with conventional social networks in which a first person becomes “connected” to a second person prior to being able to interact with that person.

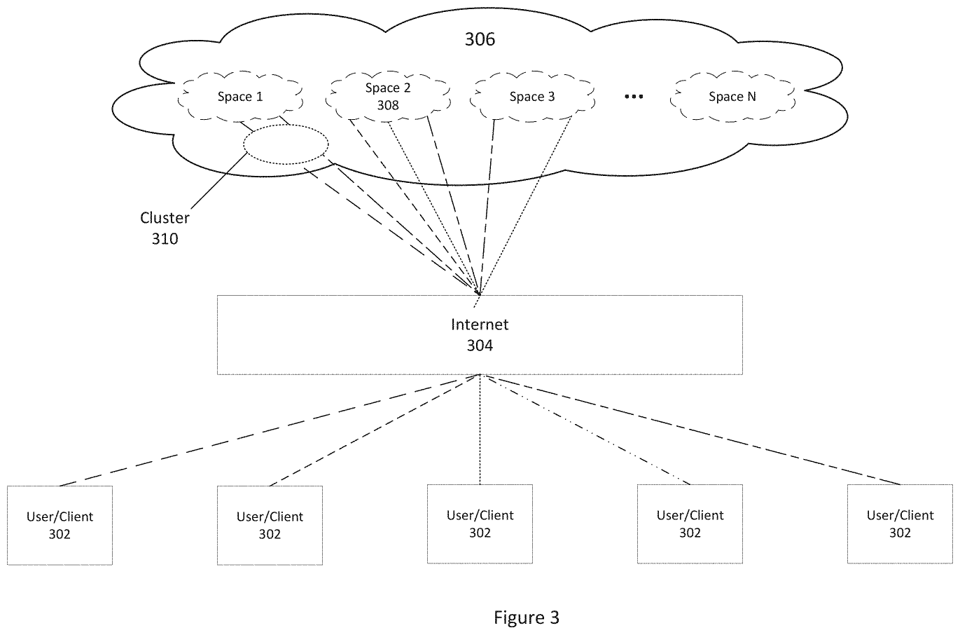

FIG. 3 is a diagram illustrating a clustering architecture that may be used in implementing an embodiment of the disclosure. As suggested by the figure, in one embodiment, a high-performance computing (HPC) cluster architecture may be used to efficiently provide access for multiple users to a space or place-based social network, and to each other. This architecture may be used to provide a uniform user experience for members of a specific space or place-based social network.

As suggested by the figure, in one embodiment, each user's device represents a node or client 302 in the architecture. Each node communicates through a network (typically the Internet 304) with a server/platform 306 that hosts webpages or websites for a space, place, event, or activity. These are indicated as Space 1, Space 2, Space 3, . . . Space N (elements 308) in the figure. Users may be associated (i.e., a member of) multiple space or place-based social networks. Each set of users that are associated with a space or place-based social network may be clustered as suggested by (HPC) Cluster 310 in the figure to provide efficient scheduling of user interactions with the webpage or website and/or with each other. The clustering architecture is optimized to perform common tasks. A user's device (e.g., mobile phone, tablet, laptop, desktop, or TV) functions as a node. A scheduler performs job handling functions for the users connected via the cluster.

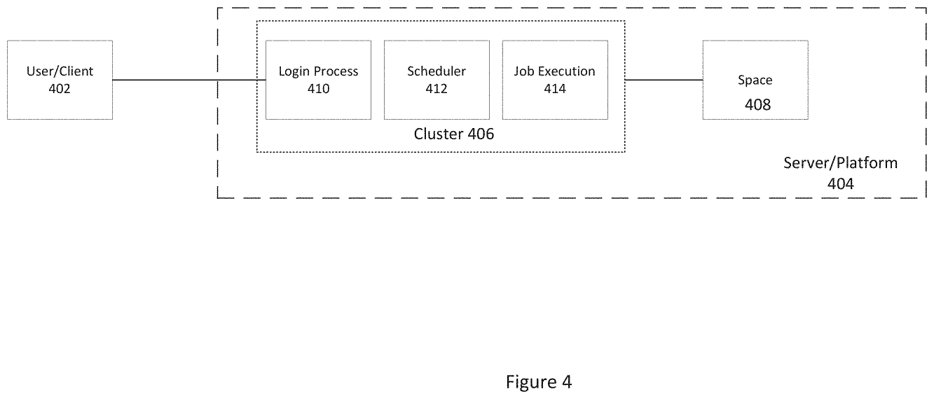

FIG. 4 is a diagram illustrating elements or processes that may be part of a cluster of the architecture illustrated in FIG. 3. As shown in the figure, in one embodiment each user/client device 402 connects to server/platform 404 and is grouped into one or more clusters 406, with each cluster providing access to a Space 408. Each user/client may be grouped into more than one cluster based on the Spaces they are interested in, that is the Spaces that represent a space, place, event, activity, or experience for which they desire to join an associated space or place-based social network. Each cluster 406 may be configured to comprise a login process 410, a scheduler process 412, and a job executing process 414, as suggested by the figure. Other users/clients (not shown) interested in the same Space 408 may be grouped into the same cluster 406.

Many types of events or places can benefit from stimulating the interest of prospective customers in visiting the place or attending the event. This form of marketing is especially necessary and effective when interest in a place or event is based at least in part on an exchange of information between people who interact socially. However, if members of a community who might be interested in an event, such as a play, concert, or art exhibit have no way to gather information about it or interact with people who have attended the event (or are otherwise knowledgeable about the event), then it may be much more difficult to effectively market the event or encourage people to visit a location, etc.

This can be a particular problem when conventional marketing methods (such as advertising and targeted messaging) are too expensive to be a realistic option for the promoters or organizers of an event or activity. Further, while conventional social networks provide a way for people to interact and exchange information, existing conventional social networks require that someone be a member and become “connected” to others before being able to send information to or receive information from other members. While this makes business sense (particularly for the exchange of personal or private information), it may not be effective for marketing an event unless many of the network members are interested in an event and/or have network relationships that would lead them to receive information about the event.

Embodiments of the system, platform, and methods disclosed herein are directed to overcoming the limitations associated with conventional approaches to creating, operating, and administering a social network for purposes of marketing or advertising a place, location, space, activity, or event, both individually and collectively. In some embodiments, the disclosed system and methods enable an event or activity organizer or administrator (or owner or caretaker of a space or place) to establish an account with a provider of social network-based services, and to use those services to “connect” persons interested in a space, place, location, event, or activity to others having a similar interest, and to obtain information or other content regarding the space, place, etc.

Embodiments of the disclosed system and methods are directed to systems, apparatuses, and methods for creating and using a social network to provide services related to the marketing and advertising of a space, place, activity, or event, such as a park, theater, play, lecture, movie, game, or concert. In some embodiments, a social network webpage is created for an event, activity, location, or venue instead of for an individual or a group of individuals (as is typical of conventional social networks). In this sense, the disclosed system creates a social network based on a space, location, event, theme, etc. instead of a person. Using this approach, an administrator for the webpage (who is typically associated with the space, place, etc.) or social network services platform operator can overcome many of the disadvantages of conventional social networking service applications for the marketing of and stimulating interest in a space, place, event, or activity.

As one example of how this form of social network may assist in marketing, this paradigm shift allows a form of “competition” to be developed between places, activities, or events. For example, in such cases, the application or service may be configured to implement a counting of followers and “likes” for each space, place, activity, event, or type of event. In addition to fostering a “competition”, this may result in creating a virtuous stimulus that results in improving the performance, appearance, or desirability of each place or event (such as improving marketing efforts, changing the type of events presented, etc.).

In some embodiments, the functionality and services provided by the system and methods disclosed herein may be made available to multiple users by accessing an account maintained by a server or service platform. Such a server or service platform may be termed a form of Software-as-a-Service (SaaS). In such an architecture, each account may be associated with a space, place, event, or activity, or with an owner, operator, caretaker, or organizer of a space, place, event, or activity. In some embodiments, each such account may contain multiple sub-accounts with each sub-account associated with a specific user or member of a space-based social network for a space, place, event, or activity.

In one implementation environment, an operator of a multi-tenant platform or system may provide each event, performer, facility, or location/space with a separate account to be used to market an event or setting, and to create a social network directed to the event or setting. In this way, each event, performer, facility, etc. is associated with a separate account or tenant of the multi-tenant platform.

Applications installed on the platform may provide an event or place manager with additional business-related services or functionality, such as communications, additional marketing services, advertising services, data analysis for data related to participants in the social network or communications regarding the event or place, financial or accounting services related to the event, management of games or competitions built around an event or events, etc.

Note that one or more aspects, capabilities, or functions of the disclosed system or its associated processes may be implemented in forms such as a web service for hosting webpages directed to performers, facilities, or events, and/or a client-side application for communicating with a server that hosts the webpages and manages the processes for requesting, receiving, and evaluating content regarding an event or setting.

A multi-tenant architecture provides a means for multiple accounts (tenants) and users to store and access their data, and to utilize specific applications that reside on a remote platform. The platform is typically implemented as a set of servers or server groups and is administered and operated by another party that provides use of the platform infrastructure as a service to the accounts (tenants) and to each account's users. This service may provide data storage, computational processing power, data analytics, and applications or workflows that may be executed with reference to an account's data (in whole or in part, and account-wide or user-specific). In some cases, such services have been described as Software-as-a-Service (SaaS), cloud-based services, web-services, or remote services.

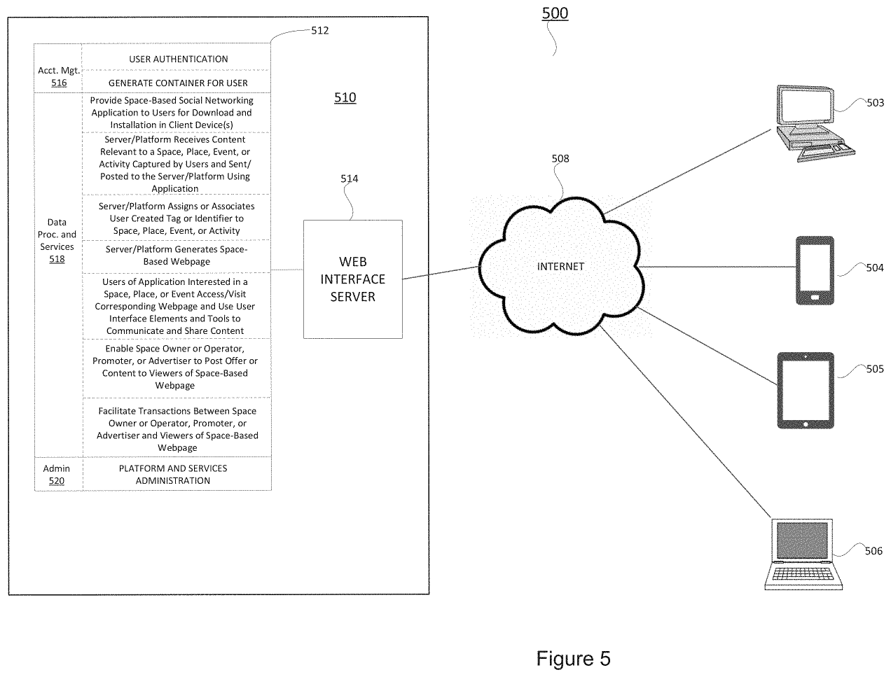

FIGS. 5-7 are diagrams illustrating a deployment of the system and methods described herein as a service or application provided through a Software-as-a-Service or Multi-Tenant platform, in accordance with some embodiments. FIG. 5 is a diagram illustrating a SaaS system in which an embodiment of the disclosure may be implemented.

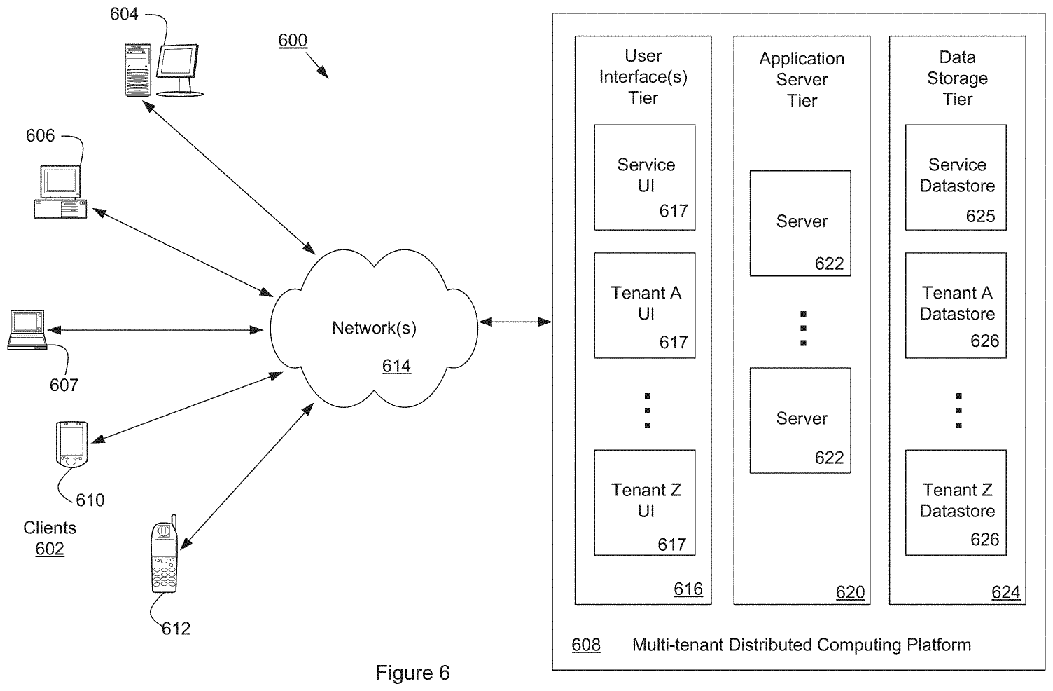

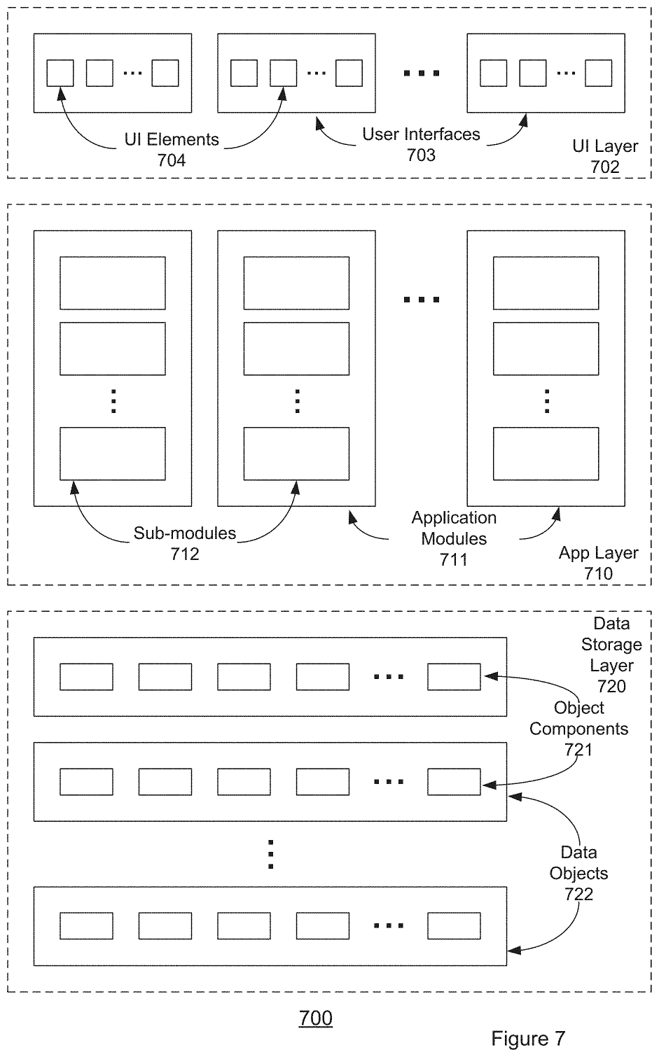

FIG. 6 is a diagram illustrating elements or components of an example operating environment in which an embodiment of the disclosure may be implemented. FIG. 7 is a diagram illustrating additional details of the elements or components of the multi-tenant distributed computing service platform of FIG. 6, in which an embodiment of the disclosure may be implemented.

In some embodiments, the system or service(s) described herein may be implemented as micro-services, processes, workflows, or functions performed in response to a user request. The micro-services, processes, workflows, or functions may be performed by a server, data processing element, platform, or system. In some embodiments, the services may be provided by a service platform located “in the cloud”. In such embodiments, the platform is accessible through APIs and SDKs. The described data processing and services may be provided as micro-services within the platform for each of multiple users or companies. The interfaces to the micro-services may be defined by REST and GraphQL endpoints. An administrative console may allow users or an administrator to securely access the underlying request and response data, manage accounts and access, and in some cases, modify the processing workflow or configuration.

Note that although FIGS. 5-7 illustrate a multi-tenant or SaaS architecture that may be used for the delivery of business-related or other applications and services to multiple accounts/users, such an architecture may also be used to deliver other types of data processing services and provide access to other applications. For example, such an architecture may be used to provide the data processing, space-based social network, and related services described herein.

Although in some embodiments, a platform or system of the type illustrated in FIGS. 5-7 may be operated by a 3^{rd} party provider to provide a specific set of business-related applications, in other embodiments, the platform may be operated by a provider and a different business may provide the applications or services for users through the platform. For example, some of the functions and services described with reference to FIGS. 5-7 may be provided by a 3^{rd} party with the provider of the services (i.e., the platform operator) maintaining an account on the platform for each company or business establishing a space-based social network to provide services to those interested in the space, place, etc.

FIG. 5 is a diagram illustrating a system 500 in which an embodiment of the disclosure may be implemented or through which an embodiment of the services described herein may be accessed. In accordance with the advantages of an application service provider (ASP) hosted business service system (such as a multi-tenant data processing platform), users of the services described herein may comprise individuals, businesses, stores, organizations, etc. A user may access the services using any suitable client, including but not limited to desktop computers, laptop computers, tablet computers, scanners, smartphones, etc. In general, any client device having access to the Internet may be used to participate in a space or place-based social network and its capabilities. Users interface with the service platform across the Internet 508 or another suitable communications network or combination of networks. Examples of suitable client devices include desktop computers 503, smartphones 504, tablet computers 505, or laptop computers 506.

System 510, which may be hosted by a third party, may include a set of services 512 and a web interface server 514, coupled as shown in FIG. 5. It is to be appreciated that either or both services 512 and the web interface server 514 may be implemented on one or more different hardware systems and components, even though represented as singular units in FIG. 5. Services 512 may include one or more functions or operations for providing the functions and processes described herein.

In some embodiments, the set of services or applications available to a company or user may include one or more that perform the functions and methods described herein with reference to the enclosed figures. As examples, in some embodiments, the set of applications, functions, operations or services made available through the platform or system 510 may include:
account management services 516, such as
   a process or service to authenticate a person wishing to access the services/applications available through the platform (such as credentials or proof of purchase, verification that a person or organization is authorized to use the services, or authentication data provided by a downloaded application, as examples);
   a process or service to generate a container or instantiation of the services, methodology, applications, functions, and operations described, where the instantiation may be customized for a particular user or company; and
   other forms of account management services;
a set 518 of data processing services, applications, functionality, etc., such as a process or service for one or more of:
   Providing A Space-Based Social Networking Application for Download and Installation in Client Device(s);
      This may be provided directly through a download or indirectly by linking to an application storage element or a stored browser plug-in;
   Enabling a Server/Platform to Receive Content Relevant to a Space, Place, Event, or Activity Captured by Users and Sent/Posted to the Server/Platform Using the Application;
      The content captured or created by a user may be uploaded to a server/platform using the installed application, or may be posted directedly to a webpage of an operator of the platform;
   Assigning a Tag or Other Form of Identifier to the Received Content or Associating the Received Content with a User Created Tag or Identifier;
   Executing Logic at the Server/Platform to Determine Whether to Create a Space-Based Webpage for the Space, Place, Event, or Activity (optional);
      As described, in some embodiments, the executed logic may determine whether a threshold number of posts have been received or a threshold number of individual posters have provided content in deciding whether to create a space or place-based webpage;
      In some embodiments, the executed logic may determine if the provided content has one or more desired characteristics (such as format, resolution, presence of keywords, etc.) in deciding whether to create a space or place-based webpage;
   Server/Platform Generates a Space-Based Webpage for the Space, Place, Event, or Activity;
      The generated webpage (or website) is hosted by the server/platform and nay be associated with an account for a specific space, place, event, or activity (or an owner or operator of one or more of those);
   Enable Users of Application Interested in a Space, Place, Event, or Activity Who Access/Visit Corresponding Webpage to Communicate and Share Content;
      This may include by providing a user interface and set of tools to enable posting of content, communications with other users, and/or communications with an owner or operator of a space, place, event, activity, etc.;
   Enable Space Owner, Operator, Promoter, or Advertiser to Post Offer or Content to Viewers of Space-Based Webpage;
      This may include generating recommendations to users based on data obtained through the server/platform and one or more of the hosted accounts/social networks using a trained model, rule-set, etc.; and
   Facilitate Transactions Between Space Owner, Operator, Promoter, or Advertiser and Viewers of Space-Based Webpage;
      This may include providing a set of transactions that users can engage in with other users and/or an owner or operator, including ticket sales, discounted purchases, creation and distribution of content, packages of experiences;
         In some embodiments, this may include payment processing services;
administrative services 520, such as
   a process or services to enable the provider of the services and/or the platform to administer and configure the processes and services provided to users.

The platform or system shown in FIG. 5 may be hosted on a distributed computing system made up of at least one, but likely multiple, “servers.” A server is a physical computer dedicated to providing data storage and an execution environment for one or more software applications or services intended to serve the needs of the users of other computers that are in data communication with the server, for instance via a public network such as the Internet. The server, and the services it provides, may be referred to as the “host” and the remote computers, and the software applications running on the remote computers being served may be referred to as “clients.” Depending on the computing service(s) that a server offers it could be referred to as a database server, data storage server, file server, mail server, print server, web server, etc. A web server is a most often a combination of hardware and the software that helps deliver content, commonly by hosting a website, to client web browsers that access the web server via the Internet.

FIG. 6 is a diagram illustrating elements or components of an example operating environment 600 in which an embodiment of the disclosure may be implemented. As shown, a variety of clients 602 incorporating and/or incorporated into a variety of computing devices may communicate with a multi-tenant service platform 608 through one or more networks 614. For example, a client may incorporate and/or be incorporated into a client application (e.g., software) implemented at least in part by one or more of the computing devices. Examples of suitable computing devices include personal computers, server computers 604, desktop computers 606, laptop computers 607, notebook computers, tablet computers or personal digital assistants (PDAs) 610, smart phones 612, cell phones, and consumer electronic devices incorporating one or more computing device components, such as one or more electronic processors, microprocessors, central processing units (CPU), or controllers. Examples of suitable networks 614 include networks utilizing wired and/or wireless communication technologies and networks operating in accordance with any suitable networking and/or communication protocol (e.g., the Internet).

The distributed computing service/platform (which may also be referred to as a multi-tenant data processing platform) 608 may include multiple processing tiers, including a user interface tier 616, an application server tier 620, and a data storage tier 624. The user interface tier 616 may maintain multiple user interfaces 617, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs).

The default user interface may include user interface components enabling a tenant to administer the tenant's access to and use of the functions and capabilities provided by the service platform. This may include accessing tenant data, launching an instantiation of a specific application, causing the execution of specific data processing operations, etc. Each application server or processing tier 622 shown in the figure may be implemented with a set of computers and/or components including computer servers and processors, and may perform various functions, methods, processes, or operations as determined by the execution of a software application or set of instructions. The data storage tier 624 may include one or more data stores, which may include a Service Data store 625 and one or more Tenant Data stores 626. Data stores may be implemented with any suitable data storage technology, including structured query language (SQL) based relational database management systems (RDBMS).

Service Platform 608 may be multi-tenant and may be operated by an entity to provide multiple tenants with a set of business-related or other data processing applications, data storage, and functionality. For example, the applications and functionality may include providing web-based access to the functionality used by a business to provide services to end-users, thereby allowing a user with a browser and an Internet or intranet connection to view, enter, process, or modify certain types of information. Such functions or applications are typically implemented by one or more modules of software code/instructions that are maintained on and executed by one or more servers 622 that are part of the platform's Application Server Tier 620. As noted with regards to FIG. 5, the platform system shown in FIG. 6 may be hosted on a distributed computing system made up of at least one, but typically multiple, “servers.”

As mentioned, rather than build and maintain such a platform or system themselves, a business may utilize systems provided by a third party. A third party may implement a business system/platform as described above in the context of a multi-tenant platform, where individual instantiations of a business' data processing workflow (such as the data processing and space-based social network related services described herein) are provided to users, with each company/business representing a tenant of the platform. One advantage to such multi-tenant platforms is the ability for each tenant to customize their instantiation of the data processing workflow to that tenant's specific business needs or operational methods. Each tenant may be a business or entity that uses the multi-tenant platform to provide business services and functionality to multiple users.

FIG. 7 is a diagram illustrating additional details of the elements or components of the multi-tenant distributed computing service platform of FIG. 6, in which an embodiment of the disclosure may be implemented. The software architecture shown in FIG. 7 represents an example of an architecture which may be used to implement an embodiment of the invention. In general, an embodiment of the invention may be implemented using a set of software instructions that are designed to be executed by a suitably programmed processing element (such as a CPU, microprocessor, processor, controller, computing device, etc.). In a complex system such instructions are typically arranged into “modules” with each such module performing a specific task, process, function, or operation. The entire set of modules may be controlled or coordinated in their operation by an operating system (OS) or other form of organizational platform.

As noted, FIG. 7 is a diagram illustrating additional details of the elements or components 700 of a multi-tenant distributed computing service platform, in which an embodiment of the invention may be implemented. The example architecture includes a user interface layer or tier 702 having one or more user interfaces 703. Examples of such user interfaces include graphical user interfaces and application programming interfaces (APIs). Each user interface may include one or more interface elements 704. For example, users may interact with interface elements to access functionality and/or data provided by application and/or data storage layers of the example architecture. Examples of graphical user interface elements include buttons, menus, checkboxes, drop-down lists, scrollbars, sliders, spinners, text boxes, icons, labels, progress bars, status bars, toolbars, windows, hyperlinks, and dialog boxes. Application programming interfaces may be local or remote and may include interface elements such as parameterized procedure calls, programmatic objects, and messaging protocols.

The application layer 710 may include one or more application modules 711, each having one or more sub-modules 712. Each application module 711 or sub-module 712 may correspond to a function, method, process, or operation that is implemented by the module or sub-module (e.g., a function or process related to providing business related data processing and services to a user of the platform). Such function, method, process, or operation may include those used to implement one or more aspects of the disclosed system and methods, such as for one or more of the processes, services, or functions described herein and with reference to the Figures:
Providing A Space-Based Social Networking Application for Download and Installation in Client Device(s);
   This may be provided directly through a download or indirectly by linking to an application storage element or a stored browser plug-in;
Enabling a Server/Platform to Receive Content Relevant to a Space, Place, Event, or Activity Captured by Users and Sent/Posted to the Server/Platform Using the Application;
   The content captured or created by a user may be uploaded to a server/platform using the installed application, or may be posted directedly to a webpage of an operator of the platform;
Assigning a Tag or Other Form of Identifier to the Received Content or Associating the Received Content with a User Created Tag or Identifier;
Executing Logic at the Server/Platform to Determine Whether to Create a Space-Based Webpage for the Space, Place, Event, or Activity (optional);
   As described, in some embodiments, the executed logic may determine whether a threshold number of posts have been received or a threshold number of individual posters have provided content in deciding whether to create a space or place-based webpage;
   In some embodiments, the executed logic may determine if the provided content has one or more desired characteristics (such as format, resolution, presence of keywords, etc.) in deciding whether to create a space or place-based webpage;
Server/Platform Generates a Space-Based Webpage for the Space, Place, Event, or Activity;
   The generated webpage (or website) is hosted by the server/platform and nay be associated with an account for a specific space, place, event, or activity (or an owner or operator of one or more of those);
Enable Users of Application Interested in a Space, Place, Event, or Activity Who Access/Visit Corresponding Webpage to Communicate and Share Content;
   This may include by providing a user interface and set of tools to enable posting of content, communications with other users, and/or communications with an owner or operator of a space, place, event, activity, etc.;
Enable Space Owner, Operator, Promoter, or Advertiser to Post Offer or Content to Viewers of Space-Based Webpage;
   This may include generating recommendations to users based on data obtained through the server/platform and one or more of the hosted accounts/social networks using a trained model, rule-set, etc.; and
Facilitate Transactions Between Space Owner, Operator, Promoter, or Advertiser and Viewers of Space-Based Webpage;
   This may include providing a set of transactions that users can engage in with other users and/or an owner or operator, including ticket sales, discounted purchases, creation and distribution of content, packages of experiences;
      In some embodiments, this may include payment processing services.

The application modules and/or sub-modules may include any suitable computer-executable code or set of instructions (e.g., as would be executed by a suitably programmed processor, microprocessor, or CPU), such as computer-executable code corresponding to a programming language. For example, programming language source code may be compiled into computer-executable code. Alternatively, or in addition, the programming language may be an interpreted programming language such as a scripting language. Each application server (e.g., as represented by element 622 of FIG. 6) may include each application module. Alternatively, different application servers may include different sets of application modules. Such sets may be disjoint or overlapping.

The data storage layer 720 may include one or more data objects 722 each having one or more data object components 721, such as attributes and/or behaviors. For example, the data objects may correspond to tables of a relational database, and the data object components may correspond to columns or fields of such tables. Alternatively, or in addition, the data objects may correspond to data records having fields and associated services. Alternatively, or in addition, the data objects may correspond to persistent instances of programmatic data objects, such as structures and classes. Each data store in the data storage layer may include each data object. Alternatively, different data stores may include different sets of data objects. Such sets may be disjoint or overlapping.

Note that the example computing environments depicted in FIGS. 3-5 are not intended to be limiting examples. Further environments in which an embodiment of the invention may be implemented in whole or in part include devices (including mobile devices), software applications, systems, apparatuses, networks, SaaS platforms, IaaS (infrastructure-as-a-service) platforms, or other configurable components that may be used by multiple users for data entry, data processing, application execution, or data review.

The disclosure includes the following clauses and embodiments:

1. A space-based social network system, comprising:

a posting management unit for managing information regarding a space, place, event, or activity that is posted to a platform and associated with an identifier;

a spatial page generator for generating a webpage associated with the identifier; and

a process or element that enables communication between a first viewer and a second viewer of the generated webpage.

2. The system of clause 1, further comprising an application downloaded from the platform to a client device, wherein when installed in the client device, the application enables a user of the client device to post information to the platform.

3. The system of clause 1, wherein the posting management unit assigns the identifier to the information.

4. The system of claim 3, wherein the posting management unit assigns the identifier to the information in response to determining that a pre-determined number of posts containing information about the space, place, event, or activity have been received at the platform.

5. The system of clause 2, wherein the application enables the user to assign an identifier to the information posted to the platform.

6. The system of clause 4, wherein if the pre-determined number of posts containing information about the space, place, event, or activity have not been received at the platform, the posting management unit stores the received information on the platform.

The disclosure also includes the following clauses and embodiments:

1. A system for marketing a space, place, event, or activity, comprising:

a platform hosting a plurality of accounts, wherein each account is associated with one or more hosted webpages, with at least one webpage for each account including information regarding the space, place, event, or activity;

an electronic processor programmed with a set of instructions, wherein when executed, the instructions cause the system to
provide a user interface, the user interface permitting a person to navigate to a hosted web page associated with one of the plurality of accounts and containing information regarding the space, place, event, or activity, and after navigating to the hosted webpage to perform the following functions
   register to become a member of a network of persons interested in the space, place, event, or activity;
   post a message to some or all the members of the network;
   view or respond to a message posted by another member of the network;
   post content to the hosted webpage; and
   view content posted to the webpage.

2. The system of clause 1, wherein the posted message or content is also distributed to persons who are not members of the network, but who are believed to be interested in the space, place, event, or activity.

3. The system of clause 1, further comprising a search process operating to enable a user of the platform to search a set of data, the set of data including data regarding one or more of the spaces, places, events, or activities for which information is included on the hosted webpages.

6. The system of clause 1, wherein the posted content is one or more of an image, a video, a review, a description, a comment, a text document, a message, or a link to a web page.

7. The system of clause 1, wherein the platform is a multi-tenant platform that includes one or more executable applications that may be utilized by an account.

8. The system of clause 7, wherein the one or more executable applications include one or more of a financial application, a marketing application, an advertising application, or a communications application.

9. A method of marketing a specific space, place, event, or activity, comprising:

providing a platform hosting a plurality of accounts, wherein each account is associated with one or more hosted webpages, with at least one webpage for each account including information regarding a space, place, event, or activity;

providing a user interface, the user interface operating to permit a person interested in a specific space, place, event, or activity to navigate to a hosted webpage associated with the specific space, place, event, or activity;

enabling the person to register to become part of a network of persons interested in the specific space, place, event, or activity;

enabling the person to post a message to some or all the members of the network;

enabling the person to view or respond to a message posted by another member of the network;

enabling the person to post content to the hosted webpage; and

enabling the person to view content posted to the webpage.

10. The method of clause 9, further comprising providing a search process operating to enable a user of the platform to search a set of data, the set of data including data regarding one or more of the spaces, places, events, or activities for which information is included on the hosted webpages.

11. The system of clause 9, wherein the posted content is one or more of an image, a video, a review, a description, a comment, a text document, a message, or a link to a web page.

12. A system for marketing a specific space, place, event, or activity, comprising:

a platform hosting a plurality of accounts, each account associated with one or more hosted web pages, with at least one web page for each account including information regarding a space, place, event, or activity;

an electronic processor programmed with a set of instructions, wherein when executed, the instructions cause the system to provide a user interface, the user interface operating to permit a person to navigate to a hosted web page associated with one of the plurality of accounts and containing information regarding a space, place, event, or activity, and after navigating to the hosted web page to perform the following functions to become part of a network of persons interested in the specific space, place, event, or activity;

create and distribute a message to some or all the members of the network, the message offering a payment for content relevant to the space, place, event, or activity;

receive or access content submitted by one or more recipients of the distributed message;

submit an evaluation of one or more items of content submitted by one or more recipients of the distributed message;

indicate a level of compensation to be awarded to one or more of the evaluated item or items of content; and

initiate a process to award the indicated level of compensation to a submitter of one or more of the evaluated items of content.

13. A method of marketing a space, place, event, or activity, comprising:

providing a user interface, the user interface operating to permit a person interested in a specific space, place, event, or activity to navigate to a hosted web page associated with the space, place, event, or activity;

enabling the person to register to become part of a network of persons interested in the specific space, place, event, or activity;

enabling the person to create and distribute a message to some or all the members of the network, the message offering a payment for content relevant to the space, place, event, or activity;

enabling the person to receive or access content submitted by one or more recipients of the distributed message;

enabling the person to submit an evaluation of one or more items of content submitted by one or more recipients of the distributed message;

enabling the person to indicate a level of compensation to be awarded to one or more of the evaluated item or items of content; and

enabling the person to initiate a process to award the indicated level of compensation to a submitter of one or more of the evaluated items of content.

The disclosure further includes the following clauses and embodiments:

1. A method for creating a social network, comprising:

providing a social networking application for download and installation in a user's client device;

receiving content from the user device relevant to a space, place, event, or activity at a server platform and sent to the server platform using the social networking application;

assigning or associating a tag or identifier to the space, place, event, or activity;

generating a webpage corresponding to the space, place, event, or activity; and

providing a tool to permit viewers of the generated webpage to communicate with each other and to share content about the space, place, event, or activity.

2. The method of clause 1, wherein at least some viewers of the generated webpage are not connected to each other through the social network.

3. The method of clause 1, further comprising:

enabling a space, place, event, or activity owner, operator, promoter, or advertiser to post an offer or content to viewers of the webpage; and

facilitating a transaction between the owner, operator, promoter, or advertiser and a viewer of the webpage.

4. The method of clause 3, wherein the posted offer or content is one of a ticket to a space, place, event, or activity, an added value service, a package of events or activities, or an offer to host an event.

5. The method of clause 1, wherein the server platform generates the webpage in response to receiving content from a pre-determined number of users or in response to receiving a pre-determined amount of content.

6. The method of clause 1, wherein assigning or associating a tag or identifier to the space, place, event, or activity is performed by an automated process, wherein the automated process is one or more of an image or object recognition technique, a trained Machine Learning (ML) model, a text or character recognition technique, a Natural Language Processing (NLP) technique, or a Natural Language Understanding (NLU) technique applied to the received content.

7. The method of clause 1, further comprising enabling a viewer of the generated webpage to experience a virtual or augmented reality experience based on the space, place, event, or activity.

8. A system, comprising:

one or more electronic processors configured to execute a set of computer-executable instructions; and

one or more non-transitory electronic data storage media containing the set of computer-executable instructions, wherein when executed, the instructions cause the one or more electronic processors to
provide a social networking application for download and installation in a user's client device;
receive content from the user device relevant to a space, place, event, or activity at a server platform and sent to the server platform using the social networking application;
assign or associate a tag or identifier to the space, place, event, or activity;
generate a webpage corresponding to the space, place, event, or activity; and
provide a tool to permit viewers of the generated webpage to communicate with each other and to share content about the space, place, event, or activity.

9. The system of clause 8, wherein at least some viewers of the generated webpage are not connected to each other through the social network.

10. The system of clause 8, wherein when executed, the instructions enable a space, place, event, or activity owner, operator, promoter, or advertiser to post an offer or content to viewers of the webpage; and

facilitate a transaction between the owner, operator, promoter, or advertiser and a viewer of the webpage.

11. The system of clause 10, wherein the posted offer or content is one of a ticket to a space, place, event, or activity, an added value service, a package of events or activities, or an offer to host an event.

12. The system of clause 8, wherein the server platform generates the webpage in response to receiving content from a pre-determined number of users or in response to receiving a pre-determined amount of content.

13. The system of clause 8, wherein assigning or associating a tag or identifier to the space, place, event, or activity is performed by an automated process, wherein the automated process is one or more of an image or object recognition technique, a trained Machine Learning (ML) model, a text or character recognition technique, a Natural Language Processing (NLP) technique, or a Natural Language Understanding (NLU) technique applied to the received content.

14. The system of clause 8, wherein when executed, the instructions enable a viewer of the generated webpage to experience a virtual or augmented reality experience based on the space, place, event, or activity.

15. One or more non-transitory computer-readable media comprising a set of computer-executable instructions that when executed by one or more programmed electronic processors, cause the processors to

provide a social networking application for download and installation in a user's client device;

receive content from the user device relevant to a space, place, event, or activity at a server platform and sent to the server platform using the social networking application;

assign or associate a tag or identifier to the space, place, event, or activity;

generate a webpage corresponding to the space, place, event, or activity; and

provide a tool to permit viewers of the generated webpage to communicate with each other and to share content about the space, place, event, or activity.

16. The one or more non-transitory computer-readable media of clause 15, wherein when executed, the instructions enable a space, place, event, or activity owner, operator, promoter, or advertiser to post an offer or content to viewers of the webpage; and

facilitate a transaction between the owner, operator, promoter, or advertiser and a viewer of the webpage.

17. The one or more non-transitory computer-readable media of clause 16, wherein the posted offer or content is one of a ticket to a space, place, event, or activity, an added value service, a package of events or activities, or an offer to host an event.

18. The one or more non-transitory computer-readable media of clause 15, wherein the server platform generates the webpage in response to receiving content from a pre-determined number of users or in response to receiving a pre-determined amount of content.

19. The one or more non-transitory computer-readable media of clause 15, wherein assigning or associating a tag or identifier to the space, place, event, or activity is performed by an automated process, wherein the automated process is one or more of an image or object recognition technique, a trained Machine Learning (ML) model, a text or character recognition technique, a Natural Language Processing (NLP) technique, or a Natural Language Understanding (NLU) technique applied to the received content.

20. The one or more non-transitory computer-readable media of clause 15, wherein when executed, the instructions enable a viewer of the generated webpage to experience a virtual or augmented reality experience based on the space, place, event, or activity.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software.

Machine learning (ML) is being used more and more to enable the analysis of data and assist in making decisions in multiple industries. To benefit from using machine learning, a machine learning algorithm is applied to a set of training data and labels to generate a “model” which represents what the application of the algorithm has “learned” from the training data. Each element (or instances or example, in the form of one or more parameters, variables, characteristics or “features”) of the set of training data is associated with a label or annotation that defines how the element should be classified by the trained model. A machine learning model in the form of a neural network is a set of layers of connected neurons that operate to make a decision (such as a classification) regarding a sample of input data. When trained (i.e., the weights connecting neurons have converged and become stable or within an acceptable amount of variation), the model will operate on a new element of input data to generate the correct label or classification as an output.

In some embodiments, certain of the methods, models or functions described herein may be embodied in the form of a trained neural network, where the network is implemented by the execution of a set of computer-executable instructions or representation of a data structure. The instructions may be stored in (or on) a non-transitory computer-readable medium and executed by a programmed processor or processing element. The set of instructions may be conveyed to a user through a transfer of instructions or an application that executes a set of instructions (such as over a network, e.g., the Internet). The set of instructions or an application may be utilized by an end-user through access to a SaaS platform or a service provided through such a platform. A trained neural network, trained machine learning model, or any other form of decision or classification process may be used to implement one or more of the methods, functions, processes, or operations described herein. Note that a neural network or deep learning model may be characterized in the form of a data structure in which are stored data representing a set of layers containing nodes, and connections between nodes in different layers are created (or formed) that operate on an input to provide a decision or value as an output.

In general terms, a neural network may be viewed as a system of interconnected artificial “neurons” or nodes that exchange messages between each other. The connections have numeric weights that are “tuned” during a training process, so that a properly trained network will respond correctly when presented with an image or pattern to recognize (for example). In this characterization, the network consists of multiple layers of feature-detecting “neurons”; each layer has neurons that respond to different combinations of inputs from the previous layers. Training of a network is performed using a “labeled” dataset of inputs in a wide assortment of representative input patterns that are associated with their intended output response. Training uses general-purpose methods to iteratively determine the weights for intermediate and final feature neurons. In terms of a computational model, each neuron calculates the dot product of inputs and weights, adds the bias, and applies a non-linear trigger or activation function (for example, using a sigmoid response function).

Any of the software components, processes or functions described in this application may be implemented as software code to be executed by a processor using any suitable computer language such as Python, Java, JavaScript, C, C++, or Perl using procedural, functional, object-oriented, or other techniques. The software code may be stored as a series of instructions, or commands in (or on) a non-transitory computer-readable medium, such as a random-access memory (RAM), a read only memory (ROM), a magnetic medium such as a hard-drive or a floppy disk, or an optical medium such as a CD-ROM. In this context, a non-transitory computer-readable medium is almost any medium suitable for the storage of data or an instruction set aside from a transitory waveform. Any such computer readable medium may reside on or within a single computational apparatus and may be present on or within different computational apparatuses within a system or network.

According to one example implementation, the term processing element or processor, as used herein, may be a central processing unit (CPU), or conceptualized as a CPU (such as a virtual machine). In this example implementation, the CPU or a device in which the CPU is incorporated may be coupled, connected, and/or in communication with one or more peripheral devices, such as display. In another example implementation, the processing element or processor may be incorporated into a mobile computing device, such as a smartphone or tablet computer.

The non-transitory computer-readable storage medium referred to herein may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DV D) optical disc drive, an internal hard disk drive, a Blu-Ray optical disc drive, or a Holographic Digital Data Storage (HDDS) optical disc drive, synchronous dynamic random access memory (SDRAM), or similar devices or other forms of memories based on similar technologies. Such computer-readable storage media allow the processing element or processor to access computer-executable process steps, application programs and the like, stored on removable and non-removable memory media, to off-load data from a device or to upload data to a device. As mentioned, with regards to the embodiments described herein, a non-transitory computer-readable medium may include almost any structure, technology or method apart from a transitory waveform or similar medium.

Certain implementations of the disclosed technology are described herein with reference to block diagrams of systems, and/or to flowcharts or flow diagrams of functions, operations, processes, or methods. It will be understood that one or more blocks of the block diagrams, or one or more stages or steps of the flowcharts or flow diagrams, and combinations of blocks in the block diagrams and stages or steps of the flowcharts or flow diagrams, respectively, may be implemented by computer-executable program instructions. Note that in some embodiments, one or more of the blocks, or stages or steps may not necessarily need to be performed in the order presented or may not necessarily need to be performed at all.

These computer-executable program instructions may be loaded onto a general-purpose computer, a special purpose computer, a processor, or other programmable data processing apparatus to produce a specific example of a machine, such that the instructions that are executed by the computer, processor, or other programmable data processing apparatus create means for implementing one or more of the functions, operations, processes, or methods described herein. These computer program instructions may also be stored in a computer-readable memory that may direct a computer or other programmable data processing apparatus to function in a specific manner, such that the instructions stored in the computer-readable memory produce an article of manufacture including instruction means that implement one or more of the functions, operations, processes, or methods described herein.

While certain implementations of the disclosed technology have been described in connection with what is presently considered to be the most practical and various implementations, it is to be understood that the disclosed technology is not to be limited to the disclosed implementations. Instead, the disclosed implementations are intended to cover various modifications and equivalent arrangements included within the scope of the appended claims. Although specific terms are employed herein, they are used in a generic and descriptive sense only and not for purposes of limitation.

This written description uses examples to disclose certain implementations of the disclosed technology, and to enable any person skilled in the art to practice certain implementations of the disclosed technology, including making and using any devices or systems and performing any incorporated methods. The patentable scope of certain implementations of the disclosed technology is defined in the claims, and may include other examples that occur to those skilled in the art. Such other examples are intended to be within the scope of the claims if they have structural and/or functional elements that do not differ from the literal language of the claims, or if they include structural and/or functional elements with insubstantial differences from the literal language of the claims.

All references, including publications, patent applications, and patents, cited herein are hereby incorporated by reference to the same extent as if each reference were individually and specifically indicated to be incorporated by reference and/or were set forth in its entirety herein.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely indented to serve as a shorthand method of referring individually to each separate value inclusively falling within the range, unless otherwise indicated herein, and each separate value is incorporated into the specification as if it were individually recited herein. All methods described herein may be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

As used herein (i.e., the claims, figures, and specification), the term “or” is used inclusively to refer to items in the alternative and in combination.

Different arrangements of the components depicted in the drawings or described above, as well as components and steps not shown or described are possible. Similarly, some features and sub-combinations are useful and may be employed without reference to other features and sub-combinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications may be made without departing from the scope of the claims below.

What is claimed is:

1. A method for creating a social network, comprising:
providing a social networking application for download and installation in a user's client device;
receiving content from the user device relevant to a space, place, event, or activity at a server platform and sent to the server platform using the social networking application;
assigning or associating a tag or identifier to the space, place, event, or activity;
generating a webpage corresponding to the space, place, event, or activity; and
providing a tool to permit viewers of the generated webpage to communicate with each other and to share content about the space, place, event, or activity.

2. The method of claim 1, wherein at least some viewers of the generated webpage are not connected to each other through the social network.

3. The method of claim 1, further comprising:
enabling a space, place, event, or activity owner, operator, promoter, or advertiser to post an offer or content to viewers of the webpage; and
facilitating a transaction between the owner, operator, promoter, or advertiser and a viewer of the webpage.

4. The method of claim 3, wherein the posted offer or content is one of a ticket to a space, place, event, or activity, an added value service, a package of events or activities, or an offer to host an event.

5. The method of claim 1, wherein the server platform generates the webpage in response to receiving content from a pre-determined number of users or in response to receiving a pre-determined amount of content.

6. The method of claim 1, wherein assigning or associating a tag or identifier to the space, place, event, or activity is performed by an automated process, wherein the automated process is one or more of an image or object recognition technique, a trained Machine Learning (ML) model, a text or character recognition technique, a Natural Language Processing (NLP) technique, or a Natural Language Understanding (NLU) technique applied to the received content.

7. The method of claim 1, further comprising enabling a viewer of the generated webpage to experience a virtual or augmented reality experience based on the space, place, event, or activity.

8. A system, comprising:
one or more electronic processors configured to execute a set of computer-executable instructions; and
one or more non-transitory electronic data storage media containing the set of computer-executable instructions, wherein when executed, the instructions cause the one or more electronic processors to
provide a social networking application for download and installation in a user's client device;
receive content from the user device relevant to a space, place, event, or activity at a server platform and sent to the server platform using the social networking application;
assign or associate a tag or identifier to the space, place, event, or activity;
generate a webpage corresponding to the space, place, event, or activity; and
provide a tool to permit viewers of the generated webpage to communicate with each other and to share content about the space, place, event, or activity.

9. The system of claim 8, wherein at least some viewers of the generated webpage are not connected to each other through the social network.

10. The system of claim 8, wherein when executed, the instructions enable a space, place, event, or activity owner, operator, promoter, or advertiser to post an offer or content to viewers of the webpage; and
facilitate a transaction between the owner, operator, promoter, or advertiser and a viewer of the webpage.

11. The system of claim 10, wherein the posted offer or content is one of a ticket to a space, place, event, or activity, an added value service, a package of events or activities, or an offer to host an event.

12. The system of claim 8, wherein the server platform generates the webpage in response to receiving content from a pre-determined number of users or in response to receiving a pre-determined amount of content.

13. The system of claim 8, wherein assigning or associating a tag or identifier to the space, place, event, or activity is performed by an automated process, wherein the automated process is one or more of an image or object recognition technique, a trained Machine Learning (ML) model, a text or character recognition technique, a Natural Language Processing (NLP) technique, or a Natural Language Understanding (NLU) technique applied to the received content.

14. The system of claim 8, wherein when executed, the instructions enable a viewer of the generated webpage to experience a virtual or augmented reality experience based on the space, place, event, or activity.

15. One or more non-transitory computer-readable media comprising a set of computer-executable instructions that when executed by one or more programmed electronic processors, cause the processors to
provide a social networking application for download and installation in a user's client device;
receive content from the user device relevant to a space, place, event, or activity at a server platform and sent to the server platform using the social networking application;
assign or associate a tag or identifier to the space, place, event, or activity;
generate a webpage corresponding to the space, place, event, or activity; and
provide a tool to permit viewers of the generated webpage to communicate with each other and to share content about the space, place, event, or activity.

16. The one or more non-transitory computer-readable media of claim 15, wherein when executed, the instructions enable a space, place, event, or activity owner, operator, promoter, or advertiser to post an offer or content to viewers of the webpage; and
facilitate a transaction between the owner, operator, promoter, or advertiser and a viewer of the webpage.

17. The one or more non-transitory computer-readable media of claim 16, wherein the posted offer or content is one of a ticket to a space, place, event, or activity, an added value service, a package of events or activities, or an offer to host an event.

18. The one or more non-transitory computer-readable media of claim 15, wherein the server platform generates the webpage in response to receiving content from a pre-determined number of users or in response to receiving a pre-determined amount of content.

19. The one or more non-transitory computer-readable media of claim 15, wherein assigning or associating a tag or identifier to the space, place, event, or activity is performed by an automated process, wherein the automated process is one or more of an image or object recognition technique, a trained Machine Learning (ML) model, a text or character recognition technique, a Natural Language Processing (NLP) technique, or a Natural Language Understanding (NLU) technique applied to the received content.

20. The one or more non-transitory computer-readable media of claim 15, wherein when executed, the instructions enable a viewer of the generated webpage to experience a virtual or augmented reality experience based on the space, place, event, or activity.
